(19) United States
(12) Patent Application Publication
(10) Pub. No.: US 2014/0309757 A1
(43) Pub. Date: Oct. 16, 2014

(54) SYSTEM AND METHOD FOR MANAGING INDUSTRIAL PROCESSES

(71) Applicants: Aurelien Le Sant, Melrose, MA (US); Jeffrey R. Titus, Groveland, MA (US)

(72) Inventors: Aurelien Le Sant, Melrose, MA (US); Jeffrey R. Titus, Groveland, MA (US)

(73) Assignee: SCHNEIDER ELECTRIC INDUSTRIES SAS, Rueil-Malmaison (FR)

(21) Appl. No.: 14/352,156

(22) PCT Filed: Oct. 1, 2012
(86) PCT No.: PCT/US12/58315

§ 371 Date: Apr. 16, 2014

Related U.S. Application Data
(60) Provisional application No. 61/550,795, filed on Oct. 24, 2011.

(51) Int. Cl. G05B 15/02

(52) U.S. Cl. CPC G05B 15/02
USPC 700/83

(57) ABSTRACT

According to at least one embodiment, an automatic control device is provided. The automatic control device is configured to publish automatic control device (ACD) information. The automatic control device includes a memory storing the ACD information, at least one processor coupled to the memory, an industrial protocol interface executed by the at least one processor and configured to exchange messages formatted according to the industrial protocol and a dashboard component executed by the at least one processor and configured to display the ACD information via at least one dashboard widget.

### RELATED APPLICATIONS

This application claims priority under 35 U.S.C. §119(e) to U.S. Provisional Application Ser. No. 61/550,795, entitled “SYSTEM AND METHOD FOR MANAGING INDUSTRIAL PROCESSES,” filed on Oct. 24, 2011, which is hereby incorporated herein by reference in its entirety.

### BACKGROUND

1. Technical Field

The technical field of this disclosure relates generally to control systems and, more particularly, to systems and methods that provide access to information regarding the operation of automatic control devices.

2. Background Discussion

An industrial control system often includes a programmable logic controller (PLC) for providing coordinated control of industrial control equipment. Examples of industrial control equipment include sensors for providing inputs to the PLC or relays for receiving outputs from the PLC, each under the control of an element controller, and each connected to the PLC over a network via a network I/O device. Industrial control using a PLC typically requires what is termed rapid scanning, meaning the continuous, rapid execution by the PLC of three main steps executed repeatedly: the acquiring of the status of each input to the PLC needed to execute so-called ladder logic for the process being controlled, the solving of the ladder logic to determine each output, and the updating of the status of the outputs. For predictable and effective industrial control, a PLC scans the connected I/O devices at a constant scan rate, and avoids becoming so involved in peripheral tasks as to depart from its regularly scheduled monitoring of the I/O devices.

The term ladder logic is used to indicate, in a form recognizable to early workers in the field of machine control, the expression of how the control elements of an industrial control system are to be controlled based on the monitoring elements of the industrial control system. The term ladder is used because the expression of the control logic is actually often in the form of a ladder, with each rung of the ladder having an output, i.e. a value for the required state of a control element, and one or more inputs, i.e. values corresponding to signals from monitoring elements.

Ordinarily, process operation is monitored, at least intermittently, by supervisory personnel via one or more central management stations. Each station samples the status of PLCs (and their associated sensors) selected by the operator and presents the data in some meaningful format. The management station may or may not be located on the same site as the monitored equipment; frequently, one central station has access to multiple sites (whether or not these perform related processes). Accordingly, communication linkage can be vital even in traditional industrial environments where process equipment is physically proximate, since at least some supervisory personnel may not be.

To facilitate the necessary communication, the PLCs and related monitoring stations are connected by a computer network. Typically, a network is organized such that any computer may communicate with any other network computer. The communication protocol provides a mechanism by which messages can be decomposed and routed to a destination computer identified by some form of address. The protocol may place a “header” of routing information on each component of a message that specifies source and destination addresses, and identifies the component to facilitate later reconstruction of the entire message by the destination computer. This approach to data transfer permits the network to rapidly and efficiently handle large communication volumes without reducing transfer speed in order to accommodate long individual messages, or requiring every network computer to process every network message. The degree of routing depends on the size of the network. Each computer of a local network typically examines the header of every message to detect matches to that computer's identifier; multiple-network systems use routing information to first direct message components to the proper network.

### SUMMARY

At least some aspects and embodiments disclosed herein provide for a highly configurable dashboard interface through which a PCL or other automatic control device provides information regarding industrial processes managed by the automatic control device or information regarding the automatic control device, itself. In at least one embodiment, the dashboard interface is the first interface displayed when a user logs into an automatic control device.

Automatic control devices may include any other equipment related at an automatic control application. Examples of automatic control devices that may display the dashboard interface include input/output modules, regulation devices, monitoring and control stations, man-machine dialogue terminals, intelligent sensor/actuators and PLCs, such as the PLC 10a described in U.S. Pat. No. 6,640,140, entitled PLC EXECUTIVE WITH INTEGRATED WEB SERVER, issued Oct. 28, 2003, which is hereby incorporated by reference herein in its entirety.

Other aspects and embodiments disclosed herein provide for a passive security interface that executes within an automatic control device. According to these embodiments, the passive security interface monitors the automatic control device for potential security issues and proactively warns users of the potential security issues. In at least one embodiment, the passive security interface also facilitates remediation of any potential security issues detected.

According to at least one embodiment, an automatic control device is provided. The automatic control device is configured to publish automatic control device (ACD) information. The automatic control device includes a memory storing the ACD information, at least one processor coupled to the memory, an industrial protocol interface executed by the at least one processor and configured to exchange messages formatted according to the industrial protocol and a dashboard component executed by the at least one processor and configured to display the ACD information via at least one dashboard widget.

In the automatic control device, the least one widget may include at least one of a data viewer widget, a graphic viewer widget, a log viewer widget, an alarm viewer widget, a rack status widget, a security status widget, a trend viewer widget, links widget, and a message board widget. The dashboard component may be further configured to receive the ACD information from another automatic control device. The dashboard component may be further configured to add a dashboard widget responsive to a drag and drop of a representation of the dashboard widget. The dashboard component may be further configured to move the at least one dashboard widget responsive to a drag and drop of the at least one dashboard widget. The dashboard component may be further configured to remove the at least one dashboard widget responsive to a click on a predefined area of the at least one dashboard widget. The dashboard component may be further configured to identify a user logged onto the automatic control device, determine that the user is associated with a dashboard widget and a plurality of options for the dashboard widget, execute the dashboard widget using the plurality of options, and display the dashboard widget.

According to another embodiment, a method of publishing ACD information is provided. The method includes acts of generating, by an automatic control device, the ACD information through management of an industrial process, storing the ACD information, executing at least one dashboard widget, and displaying the ACD information via the at least one dashboard widget.

In the method, the act of executing the least one widget may include an act of executing at least one of a data viewer widget, a graphic viewer widget, a log viewer widget, an alarm viewer widget, a rack status widget, a security status widget, a trend viewer widget, links widget, and a message board widget. The method may further include an act of receiving the ACD information from another automatic control device. The method may further include an act of adding a dashboard widget responsive to a drag and drop of a representation of the dashboard widget. The method may further include an act of moving the at least one dashboard widget responsive to a drag and drop of the at least one dashboard widget. The method may further include an act of removing the at least one dashboard widget responsive receiving a click on a predefined area of the at least one dashboard widget. The method may further include an acts of identifying a user logged onto the automatic control device, determining that the user is associated with a dashboard widget and a plurality of options for the dashboard widget, executing the dashboard widget using the plurality of options, and displaying the dashboard widget.

According to another embodiment, a non-transitory computer readable medium is provided. The computer readable medium stores sequences of instructions for publishing ACD information. The sequences of instructions include instructions encoded to instruct at least one processor to generate the ACD information through management of an industrial process, store the ACD information, execute at least one dashboard widget, and display the ACD information via the at least one dashboard widget.

On the computer readable medium, the instructions encoded to instruct the at least one processor to execute the at least one dashboard widget may further instruct the at least one processor to execute at least one of a data viewer widget, a graphic viewer widget, a log viewer widget, an alarm viewer widget, a rack status widget, a security status widget, a trend viewer widget, links widget, and a message board widget. The instructions may be encoded to further instruct the at least one processor to receive the ACD information from another automatic control device. The instructions may be encoded to further instruct the at least one processor to add a dashboard widget responsive to a drag and drop of a representation of the dashboard widget. The instructions may be encoded to further instruct the at least one processor to move the at least one dashboard widget responsive to a drag and drop of the at least one dashboard widget. The instructions may be encoded to further instruct the at least one processor to remove the at least one dashboard widget responsive receiving a click on a predefined area of the at least one dashboard widget.

Other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment or example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram including an exemplary automation monitoring system;

FIG. 2 is a schematic diagram of an exemplary automatic control device;

FIG. 3 is a schematic diagram of an exemplary computer system that may be configured to perform processes and functions disclosed herein;

FIG. 4 is a flow diagram illustrating a process of publishing information regarding one or more automatic control devices via a dashboard interface;

FIG. 5 is a flow diagram illustrating a process of self-monitoring and reporting executed by an automatic control device;

FIG. 6 is an exemplary dashboard interface screen configured to provide information regarding one or more automatic control devices;

FIG. 7 is an exemplary title bar included within some dashboard widgets;

FIG. 8 is an exemplary screen displayed by a data viewer widget;

FIG. 9 is another exemplary screen displayed by a data viewer widget;

FIG. 10 is another exemplary screen displayed by a data viewer widget;

FIG. 11 is an exemplary screen displayed by a trend viewer widget;

FIG. 12 is another exemplary screen displayed by a trend viewer widget;

FIG. 13 is an exemplary screen displayed by a rack status widget;

FIG. 14 is another exemplary screen displayed by a rack status widget;

FIG. 15 is an exemplary screen displayed by a security status widget;

FIG. 16 is an exemplary screen displayed by an alarm viewer widget;

FIG. 17 is an exemplary screen displayed by a log viewer widget;

FIG. 18 is an exemplary screen displayed by a graphic viewer widget;

FIG. 19 is another exemplary screen displayed by a graphic viewer widget;

FIG. 20 is another exemplary screen displayed by a graphic viewer widget;

FIG. 21 is another exemplary screen displayed by a graphic viewer widget;

FIG. 22 is another exemplary dashboard interface screen configured to provide information regarding one or more automatic control devices;

FIG. 23 is another exemplary dashboard interface screen configured to provide information regarding one or more automatic control devices;

FIG. 24 is another exemplary dashboard interface screen configured to provide information regarding one or more automatic control devices;

FIG. 25 is another exemplary dashboard interface screen configured to provide information regarding one or more automatic control devices;

FIG. 26 is another exemplary dashboard interface screen configured to provide information regarding one or more automatic control devices;

FIG. 27 is another exemplary dashboard interface screen configured to provide information regarding one or more automatic control devices;

FIG. 28 is another exemplary dashboard interface screen configured to provide information regarding one or more automatic control devices;

FIG. 29 is another exemplary dashboard interface screen configured to provide information regarding one or more automatic control devices;

FIG. 30 is another exemplary dashboard interface screen configured to provide information regarding one or more automatic control devices;

FIG. 31 is a flow diagram illustrating a notification process executed by a passive security component; and

FIG. 32 is an exemplary screen including information provided by a passive security component.

### DETAILED DESCRIPTION

At least some embodiments disclosed herein include apparatus and processes for providing, by an automatic control device, information regarding one or more automatic control devices via a configurable dashboard interface. This automatic control device (“ACD”) information may include one or more identifiers of the automatic control device, such as a device name or internet protocol (“IP”) address, a current state of the device, diagnostic information that may be used to determine how the device entered its current state, ladder logic that the device is configured to execute, configuration management information pertinent to the device, such as hardware and software version information, and historical information regarding the device. Additional examples of ACD information provided by the automatic control device include data descriptive of one or more industrial processes managed by the automatic control device. In one embodiment, this industrial process information is stored as one or more variable disposed within one or more tables, although other logical data structures may be employed without departing from the scope of embodiments disclosed herein. In some embodiments, ACD information is stored within local memory or another data storage included within the automatic control device. In at least one embodiment, the automatic control device provides ACD information via a configurable dashboard interface served by a web server local to the automatic control device. In other embodiments, the automatic control device provides ACD information to one or more other automatic control devices that, in turn, publish the ACD information via a dashboard interface.

In another embodiment, ACD information is provided to a computer system that is in data communication with an automatic control device via a local network. In this example, the computer system presents an interface through which the computer system receives ACD information for the automatic control device. Responsive to receiving this ACD information, the computer system provides the ACD information to a user via a user interface. According to some embodiments, this user interface includes a configurable dashboard.

Other embodiments include apparatus and processes for providing, by an automatic control device, security information regarding one or more automatic control devices via a passive security interface. The security information may identify one or more potential security issues present within an automatic control device. Further, the security information may contain links to additional information regarding the potential security issue or automation that facilitates remediation of the potential security issue.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Automation Control System

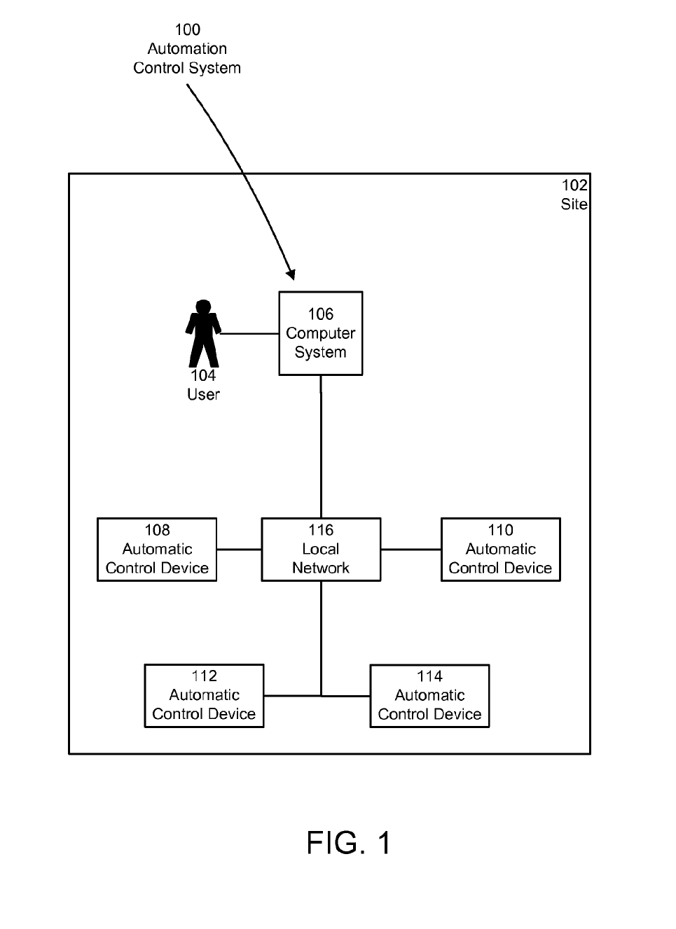

Some embodiments implement an automation control system that provides device and process monitoring via a dashboard component. Other embodiments implement an automation control system that provides security monitoring via a passive security component. FIG. 1 illustrates an automation control system 100 that may implement one or both of these components. As shown in FIG. 1, the automation control system 100 includes a computing system 106, automatic control devices 108, 110, 112, and 114, and a local communication network 116. The automation control system 100 and a user 104 of the computer system 106 are located within a site 102.

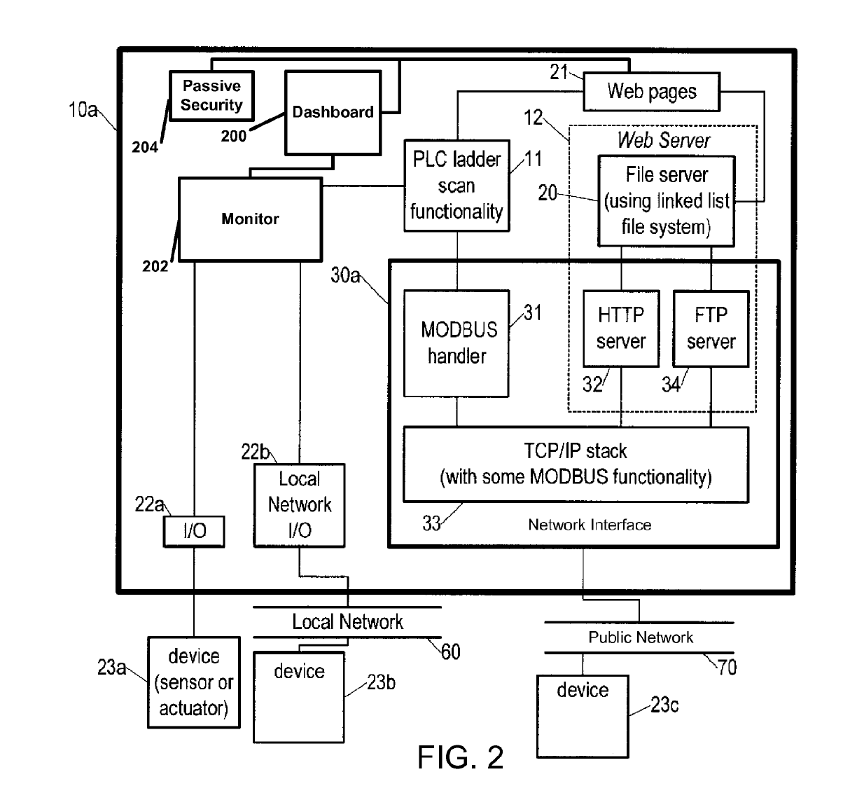

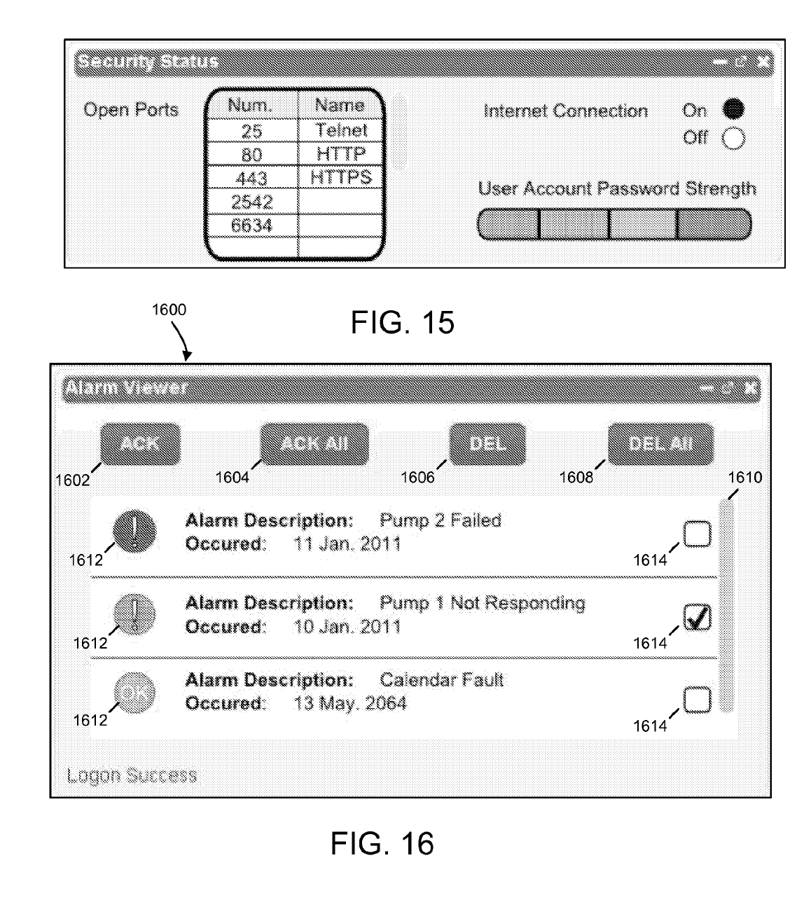

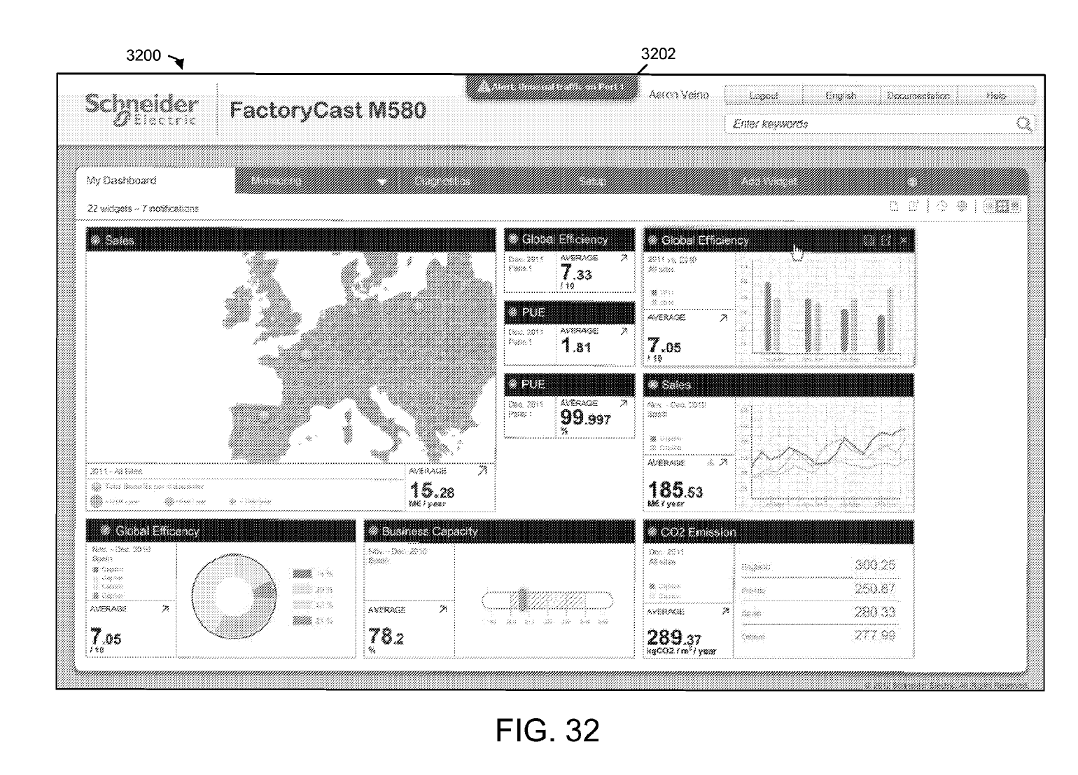

As shown in FIG. 1, the computer system 106 and the automatic control devices 108, 110, 112, and 114 exchange (i.e. send or receive) information with one another via the network 116. This information may include ACD information, which is described above. In addition, the information exchanged via the network 116 may include other information such as data summarized from ACD information or information used to render a user interface including a dashboard or passive security information within a browser. One particular example of a dashboard interface resulting from data communicated between the computer system 106 and the automatic control devices 108, 110, 112, and 114 is described below with reference to FIGS. 2, 4, and 7. Examples of browser-based user interfaces that render passive security information are described further below with reference to FIGS. 15 and 32.

The network 116 shown in FIG. 1 may include any network through which computer systems communicate data with one another. For example, the communication network may be (or be a part of) a public network, such as the internet, and may include other public or private networks such as LANs, WANs, extranets and intranets. Alternatively, the network 116 may be an Ethernet LAN running MODBUS over TCP/IP. It is to be appreciated that, in some embodiments, the network 116 includes security features that prevent unauthorized access to the network 116. In these embodiments, the computer system 106 is required to provide valid credentials prior to gaining access to the network 116.

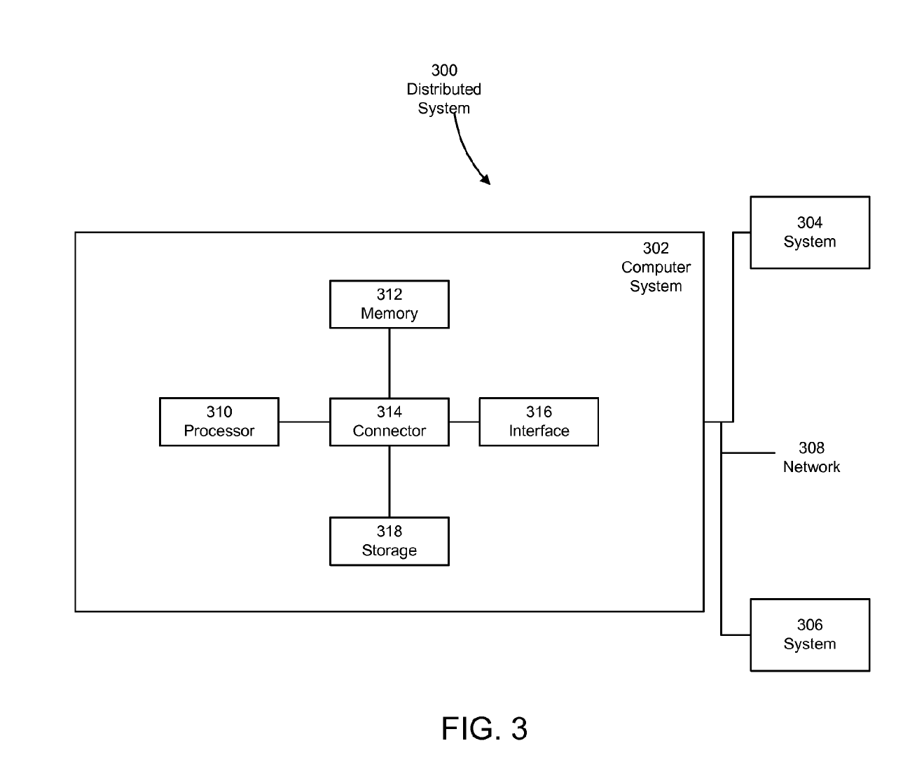

Various embodiments illustrated by FIG. 1 employ a variety of equipment and technology. For instance, in one embodiment, the computer system 106 and the network 116 each include one or more computer systems as described further below with reference to FIG. 3. Thus, the computer system 106 may be a desktop computer, laptop computer, or smart phone. In addition, the automatic control devices 108, 110, 112, and 114 shown in FIG. 1 are specialized computing devices that are specifically configured to control one or more industrial processes.

In some embodiments, the automatic control devices 108, 110, 112, and 114 include one or more components illustrated in FIG. 3, such as one or more processors, interfaces, memory or other data storage, or connectors, such as one or more busses. Furthermore, in variety of embodiments, these and other automatic control devices communicate using a variety of industrial protocols including MODBUS, UMAS, BACnet, LON, C-BUSTM, TCP/IP over Ethernet, DMX512 and JCI-N2, and wireless protocols, such as ZigBee and Bluetooth. In the embodiment illustrated in FIG. 1, the automatic control devices 108, 110, 112, and 114 transmit ACD information over the network 126 using web service calls transported over HTTP.

FIG. 2 further illustrates components that may be implemented within any of the automatic control devices 108, 110, 112, and 114. The components illustrated in FIG. 2 may be hardware components, software component or a combination of hardware and software components. In addition, the components illustrated in FIG. 2 may utilize a variety of to protocols and standards, such as any of those described with reference to FIG. 3.

As shown in FIG. 2, an exemplary PLC 10a includes a process control component 11 having ladder scan functionality, a web server component 12, a dashboard component 200, and a monitor component 202. In this example, the process control component 11 services I/O components 22a and 22b. I/O components 22a and 22b are coupled to and in data communication with devices 23a and 23b, such as a wired or wireless network. According to this example, devices 23a and 23b are used by the PLC 10a to control one or more industrial processes. Thus devices 23a and 23 may be any of several types of devices including one or more sensors or actuators.

In the example illustrated in FIG. 2, the process control component 11 executes ladder logic to determine device commands that, when executed by a device, cause the device to enter a predefined state or execute a predefined function. The device commands generated as a result of execution of the ladder logic may depend on inputs received from any devices or sensors within the PLC 10a or received from any devices or sensors in communication with the PLC 10a. While the process control component 11 executes process control logic written using ladder logic, other embodiments may execute programs written using other programming languages. Examples of such programming languages include sequential function charts, function block diagrams, structured text, instruction lists, and 984LL. Thus exemplary ACDs are not required to execute programs written using a particular programming language.

The devices that are controlled by the PLC 10a or in data communication with the PLC 10a can be coupled to the PLC 10a either directly (as is the device 23a), by a local network 60 (as is the device 23b), or by the public network 70 (as is the device 23c). In the case of the device 23c connected to the PLC 10a via the public network 70, the PLC 10a uses a network interface 30a to process input and output associated with the device 23c. The network interface includes a MODBUS handler 31 on top of a transmission control program (TCP)/Internet protocol (IP) stack 33 having some MODBUS functionality (as further described below) and providing for communication over the public network 70 according to TCP/IP.

The terminology MODBUS refers here to a family of simple, vendor-neutral communication protocols intended for supervision and control of automation equipment. In the example illustrated in FIG. 2, the TCP/IP stack is MODBUS/TCP compliant. MODBUS/TCP is a member of the family of MODBUS protocols, and MODBUS/TCP supports the use of MODBUS messaging in a networking environment using TCP/IP to protocols. In some examples, the public network interface 30a is preferably based on MODBUS TCP/IP, as defined by the Open MODBUS/TCP specification, release 1.0, which is hereby incorporated herein by reference in its entirety. The specification defines how MODBUS commands and responses are delivered over the Internet to and from a MODBUS server using the well known port 502. In the example of FIG. 2, the TCP/IP stack 33 is a custom stack and is programmed to provide any MODBUS command or message as a single packet, optimizing all MODBUS communications.

As shown in FIG. 2, the web server 12 includes both a file server 20, which may use a linked list file system, and a hypertext transfer protocol (“HTTP”) server 32, i.e., a component for communicating hypertext (used to describe a web page to a browser so that the browser can display the web page) according to HTTP. In the example shown in FIG. 2, the web server 12 also includes a file transfer protocol (“FTP”) server 34 that accepts downloads of new or replacement web pages or other files and provides them to the file server 20. In this example, the TCP/IP stack 33 determines whether an incoming message (TCP/IP packet) is for the MODBUS handler 31, the HTTP server 32, or the FTP server 34 based on the port number specified in the incoming message.

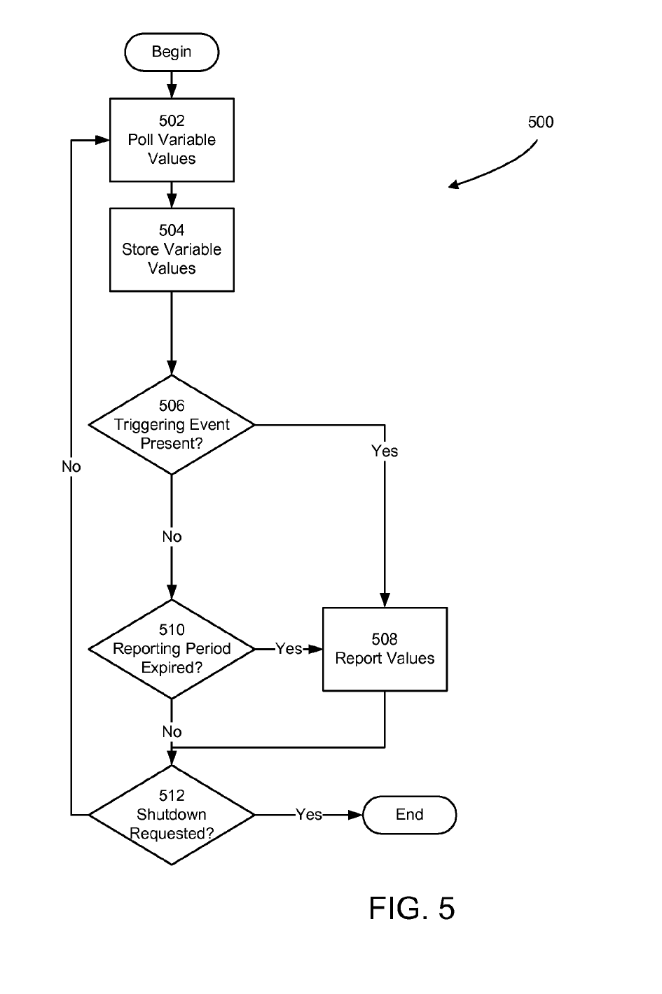

According to the example of FIG. 2, the monitor component 202 is configured to exchange information with the I/O components 22a and 22b, process control component 11, and the dashboard component 200. This information may include ACD information generated by other components of the PLC 10a and ACD information generated by other automatic control devices. In the example of FIG. 2, the monitoring component 202 is further configured to analyze received information and, depending on the content of the information and timing criteria, report information to the dashboard component 200 for publication. In some embodiments, the monitor component 202 stores, aggregates, and summarizes the ACD information prior to reporting the ACD information. Thus, unlike conventional systems, these embodiments do not include an intermediate device that serves as a data aggregator for ACD information. Further examples of self-monitoring and reporting processes executed by the monitor component 202 are described further below with reference to FIG. 5.

In example illustrated in FIG. 2, the dashboard component 200 is configured to provide a dashboard interface that displays ACD information received from the monitoring component 202 or from other components of the PLC 10a. This dashboard interface may present ACD information generated by the PLC 10a, or ACD information received from other automatic control devices. Moreover, the dashboard interface may include one or more dashboard to widgets, which are described further below. In some embodiments, the dashboard component 200 implements the dashboard interface via one or more the web pages 21.

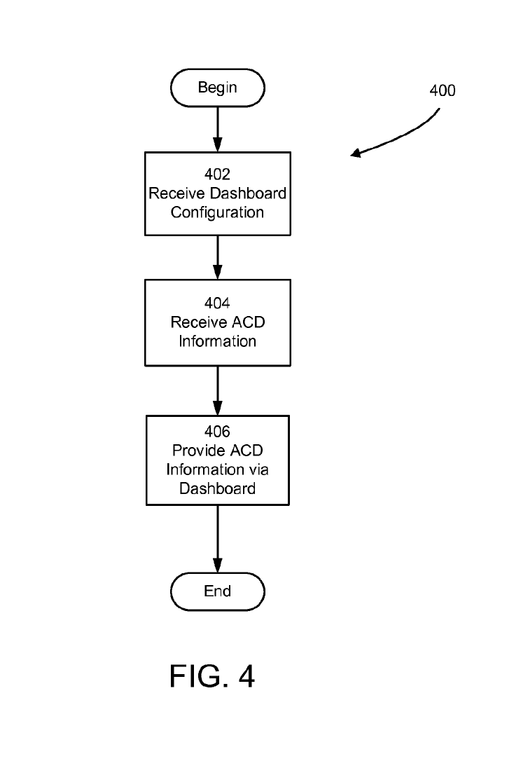

In some embodiments, the dashboard component 200 is configured to receive dashboard configuration information via a user interface and, responsive to receipt of this configuration information, alter the manner in which ACD information is displayed. For instance, according to one example, the dashboard component 200 receives an indication from the user interface that the user has performed a drag and drop operation upon one of the dashboard widgets included within the dashboard interface. Responsive to receiving this indication, the dashboard component 200 alters the location with the dashboard interface associated with the widget a new location representative of the location where the widget was dropped. In another example, the dashboard component 200 receives an indication from the user interface that the user has changed an option associated with one of the widgets. Responsive to receiving this indication, the dashboard component 200 re-executes the widget using the new option. Further examples of configuration and publication processes executed by the dashboard component 200 are described further below with reference to FIG. 4.

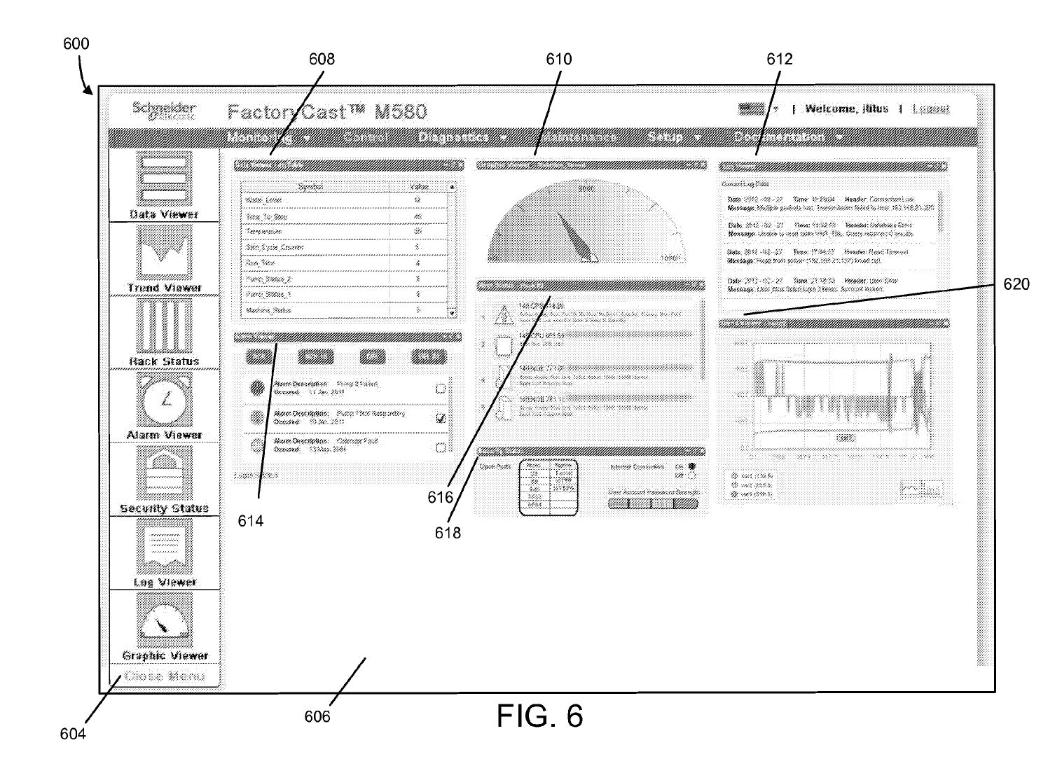

In other embodiments, each of the automatic control devices 108, 110, 112, and 114 is configured to publish ACD information regarding itself and the industrial processes it manages. For example, in one embodiment, each automatic control device publishes ACD information by providing the ACD information via to a dashboard component, such as the dashboard component 200. The dashboard component 200, in turn, presents the ACD information via a dashboard interface, such as the dashboard described further below with reference to FIG. 6. This dashboard interface may be served as part of a dedicated website by a web server resident on each automatic control device, such as the web server 12 described above with reference to FIG. 2.

According to some embodiments, each automatic control device publishes ACD information by providing the ACD information (or links to the ACD information) to other automatic control devices that, in turn, present the received ACD information via their dashboard interfaces. In some of these embodiments, the user interface that renders the dashboard for a particular automatic control device provides links to websites of other, distinct automatic control devices that are in data communication with the particular automatic control device via the network 116, thereby decreasing the number of steps required for a user to navigate ACD information for a particular site, such as the site 102 described above with reference to FIG. 1. At least one example publication process executed by an automatic control device is described further below with reference to FIG. 4.

In other embodiments, the automatic control devices 108, 110, 112, and 114 employ the monitor component 202 and the dashboard component 200 to monitor ACD information and publish the ACD information. The automatic control devices 108, 110, 112, and 114 may publish the ACD information as warranted by the importance of the ACD information, according to a periodic schedule, or in accordance with a combination of these factors. For instance, in one example, the automatic control devices 108, 110, 112, and 114 are configured to publish ACD information according to a periodic schedule designed to minimize contention for network resources. According to this example, each of the automatic control devices publishes ACD information at a different offset but at the same time interval (e.g., different 15 minute offsets every hour). In another example, the automatic control devices 108, 110, 112, and 114 publish ACD information according to the periodic schedule described above and also publish ACD information describing high importance events as quickly as possible. Examples of high importance events include imminent or extant failure of the automatic control device, failure of the equipment controlled by the automatic control device, or the existence of an input that the automatic control device is not equipped to handle (e.g., external temperature above a configured threshold, etc...). In at least one embodiment, ACD information describing an event of high importance includes a data field populated with a value that indicates the importance of the ACD information.

In other embodiments, each of the automatic control devices 108, 110, 112, and 114 includes a passive security component 204. In these embodiments, the passive security component 204 is configured to monitor the automatic control device of which it is a part for potential security issues and proactively warns users of the potential security issues. In some embodiments, the passive security component 204 is implemented within an automatic control device that does not include a dashboard component, such as the dashboard component 200 described herein. In other embodiments, the passive security component 204 is implemented as a security widget displayed within a dashboard component.

Examples of the potential security issues for an automatic control device that the passive security component 204 is configured to detect and report include the strength of the password of the user currently logged onto the automatic control device; one or more logical ports, such as TCP or UDP ports, currently open on the automatic control device and the services commonly associated therewith; whether the automatic control device is connected to the internet; changes to the process control logic stored in the automatic control device; changes to the firmware or other software components stored in the automatic control device; changes to the hardware components that comprise the automatic control device; changes in identifiers, such as IP or MAC address, of computers used by identified users to access the automatic control device; new identifiers of computers used to access the automatic control device; new user accounts stored in the automatic control device; changes in user accounts stored in the automatic control device; changes in configuration information stored in the automatic control device; traffic on a port (or the volume of requests received via a port) that exceeds a predetermined threshold; identifiers of computers that attempted to access the automatic control device that are not in the list (e.g., an Access Control List) of identifiers authorized to access the automatic control device; identifiers of files stored in the file system of the automatic control device that are unsigned; changes in locations used to access the automatic control device from previously used locations (as deducted from routing information); attempts to access non-existing pages (which may indicate a bot scanning the device for vulnerability); redirection of a web page presented by the automatic control device to a third party site (which may indicate that the page has been infected and is redirecting to an unauthorized site; the occurrence of communication request errors; and other predefined alarms identified by parameters as having a potential impact on security. In some embodiments, the passive security component 204 is configured to scan the elements described above for changes when a user logons onto the automatic device controller. In other embodiments, the passive security component 204 is configured to scan the elements described above according to a predetermined, configurable schedule parameter.

To detect changes in elements describe above (such as the process control logic, firmware, other software, hardware, computer identifiers and configuration information), some embodiments of the passive security component 204 are configured to maintain a history of a these elements in local storage. This history may include information descriptive of the actual values of the elements, such as a list of IP or MAC addresses, or configuration management information descriptive of the version of the elements, such as a hardware model number or software version number. In some embodiments, this history information further includes information descriptive of a time and user logon associated with the origin of the potential security issue (e.g., the time when a change was made to the process control logic stored on the automatic control device and the user logged on to the system when the change was made).

In at least one embodiment, the passive security component 204 is configured to present warning notifications via a banner displayed after a user with permission to execute the passive security component 204 logs onto the automatic control device. In another embodiment, the passive security component 204 is configured to presents warning notifications via a modal dialogue displayed after a user with permission to execute the passive security component 204 logs onto the automatic control device. In either of these embodiments, the passive security component 204 may require a response to a warning notification prior to allowing the web server to present subsequent web pages. In some embodiments, where the response includes an indication that the potential security issue is acceptable, the passive security component 204 may record information reflecting that the potential security issue is acceptable so that future executions of the passive security component 204 will not present a warning notification where this potential security issue is detected.

In other embodiments, the passive security component 204 is configured to take additional actions based on the information contained in a response to a warning notification. For instance, in some embodiments, upon receiving a response that includes an indication that corrective action is desirable, the passive security component 204 executes a component to facilitate correction of the potential security issue. The particular component executed to facilitate correction varies based on the potential security issue detected. For example, where the potential security issue is an unprotected connection between the internet and the automatic control device, the passive security component 204 may execute a configuration screen with configurable network parameters capable of barring unprotected connections. In another example, where the potential security issue is transgression of a threshold number of unsuccessful attempted logons, the passive security component 204 may execute a configuration screen with configurable logon parameters capable of altering logon credentials for a user.

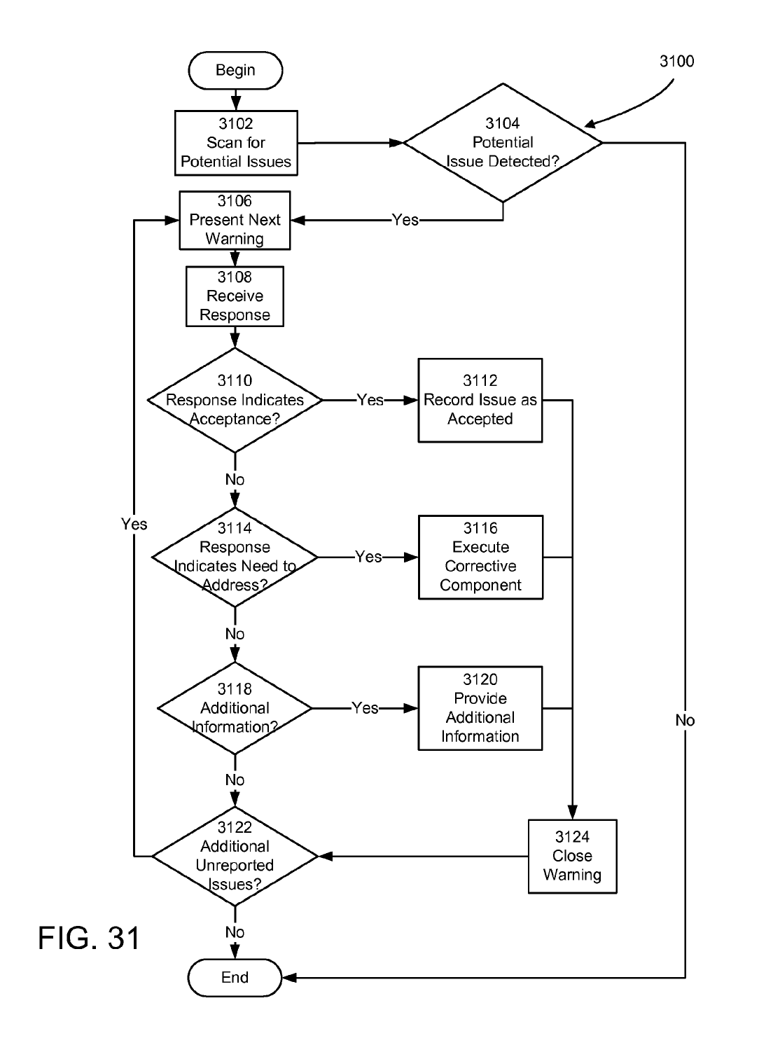

In other embodiments, responsive to receiving a response that includes a request for additional information, the passive security component 204 provides additional information regarding the potential security issue. The particular information provided varies based on the potential security issue encountered. For example, where the potential security issue is transgression of a threshold number of unsuccessful attempted logons, the passive security component 204 may provide a list of the times of execution of the unsuccessful attempts. One example of a notification process executed by the passive security component 204 is described further below with reference to FIG. 31.

In other embodiments, the automatic control devices 108, 110, 112, and 114 provide a user interface through which the automatic control devices receive configuration information. In these embodiments, this configuration information specifies how the automatic control devices are to publish ACD information. For instance, the configuration information may describe events of importance that cause the automatic control devices to publish ACD information, may specify a publication period to be followed by the automatic control devices, may specify an identifier, such as an IP address, of one or more automatic control devices to which ACD information should be published, or may specify characteristics of the dashboard interface used to display ACD information. In some embodiments, the automatic control devices 108, 110, 112, and 114 serve this user interface to browsers via a web server resident on the automatic control devices, such as the web server 12 described above with reference to FIG. 2.

Information within the components of the automation control systems 100 may be stored in any logical construction capable of holding information on a computer readable medium including, among other structures, file systems, flat files, indexed files, hierarchical databases, relational databases, or object oriented databases. The data may be modeled using unique and foreign key relationships and indexes. The unique and foreign key relationships and indexes may be established between the various fields and tables to ensure both data integrity and data interchange performance.

Information may flow between the components of the automation control system 100, or any of the elements, components and subsystems disclosed herein, using a variety of techniques. Such techniques include, for example, passing the information over a network using standard protocols, such as TCP/IP or HTTP, passing the information between modules or other components in memory and passing the information by writing to a file, database, data store, or some other non-volatile data storage device. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Embodiments of the automation control system 100 are not limited to the particular configuration illustrated in FIG. 1. Various embodiments utilize a variety of hardware components, software components and combinations of hardware and software components configured to perform the processes and functions described herein. As discussed above, in some embodiments, the automation control system 100 are implemented using one or more computer systems, such as the computer systems described further below with regard to FIG. 3.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange to data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, Jquery and Web Services. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, a connector 314, an interface 316 and data storage 318. To implement at least some of the aspects, functions and processes disclosed herein, the processor 310 performs a series of instructions that result in manipulated data. The processor 310 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 310 is connected to other system components, including one or more memory devices 312, by the connector 314.

The memory 312 stores programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the connector 314. The connector 314 may include one or more physical busses, for example, busses between components that are integrated within a same machine, but may include any communication coupling between system elements including specialized or standard computing bus technologies such as IDE, SCSI, PCI and InfiniBand. The connector 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage 318 includes a computer readable and writeable nonvolatile, or non-transitory, data storage medium in which instructions are stored that define a program or other object that is executed by the processor 310. The data storage 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage 318. The memory may be located in the data storage 318 or in the memory 312, however, the processor 310 manipulates the data within the memory, and then copies the data to the storage medium associated with the data storage 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Automation Control System Processes

As described above with reference to FIG. 1, several embodiments perform processes that publish ACD information via a dashboard interface. In some embodiments, this publication process is executed by a dashboard component, such as the dashboard component 200 described above with reference to FIG. 2. One example of the publication process is illustrated in FIG. 4. According to this example, the publication process 400 includes acts of receiving dashboard configuration information, receiving ACD information, and providing ACD information via a dashboard interface.

In act 402, the dashboard component receives dashboard configuration information. In at least one embodiment, the dashboard component receives the dashboard configuration information via a user interface served by a web server executing on the automatic control device, such as the web server 12 described above with reference to FIG. 2. The dashboard configuration information may include a variety of parameters that specify the characteristics of the dashboard interface and the components (e.g., dashboard widgets) included in the dashboard interface. In some embodiments, these parameters are user-specific and are stored in association with a user's logon credentials.

In other embodiments, the dashboard configuration information may include information specifying the location, state, and selected options of one or more dashboard widgets. According to these embodiments, a dashboard widget is a configurable component that performs specialized processing using one or more elements of ACD information as input. The processing performed by a dashboard widget is affected by the options selected for the dashboard widget. The options available for selection vary between particular types of to dashboard widgets, and some examples are described further below with reference to FIG. 6.

In some embodiments, a dashboard widget may display the ACD information, or the results of any processing performed on the ACD information by the dashboard widget, within an area of the dashboard interface allocated by the dashboard component for the dashboard widget. In some embodiments, the dashboard component positions this display area at the location specified within the dashboard configuration information. In other embodiments, during instantiation of a dashboard widget, the dashboard component assigns default state information to the dashboard widget or restores previously saved state information to the dashboard widget. State information varies between particular types of dashboard widgets and may specify characteristics of the dashboard widget, such as whether the dashboard widget is maximized, minimized, active, or inactive. Some examples of particular dashboard widgets are described further below with reference to FIG. 6.

In act 404, the dashboard component receives ACD information from one of a variety of sources, such as a sensor coupled to the automatic control device, a user interface provided by the automatic control device, or an automatic control device distinct from the automatic control device executing the dashboard component. Examples of the ACD information received include information posted by site personnel via the user interface and information descriptive of one or more industrial processes managed by the automatic control device or other, distinct automatic control devices.

In act 406, responsive to receiving the ACD information, the dashboard component publishes the ACD information by executing any dashboard widgets included within the dashboard interface and providing the results of this execution, in conjunction with the dashboard interface, to an external entity (e.g., a user interface rendered by a browser), and the publishing process 400 ends. The ACD information provided in the act 406 may include elements of ACD information received in the act 404 and results of dashboard widget processing of the received ACD information. Processes in accord with the publishing process 400 enable automatic control devices to display ACD information tailored for a particular user in the manner preferred by the user, thereby increasing the efficacy of the user interface presenting the ACD information.

Other embodiments perform processes that enable an automatic control device to monitor itself and the industrial processes controlled by the automatic control device and to report events via a dashboard component, such as the dashboard component 200 described above with reference to FIG. 2. In some embodiments, these monitoring processes are executed by a monitor component, such as the monitor component 202 described with reference to FIG. 2. One example of such a monitoring process is illustrated in FIG. 5. According to this example, the monitoring process 500 includes acts of polling variable values, storing the variable values, determining whether the variable values indicate that an event of importance has occurred, determining whether a period of time since the stored variable values were last reported has expired, publishing variable values, and determining whether shutdown of the automatic control device executing the process 500 is imminent.

In act 502, the monitor component executing the monitoring process 500 polls memory for the current value of one or more variables. The values of these variables may represent a variety of physical measurements and other information that are used as inputs to the process control logic executed by an automatic control device or that are provided as outputs resulting from the execution of the process control logic. Examples of this process control logic include, for example, ladder logic as described above. Examples of the physical phenomenon represented by variables include temperature, light levels, power levels, weight, and humidity.

In act 504, the monitor component stores the values of the polled variables in data storage, (e.g., a data buffer allocated into a table). In act 506, the monitor component analyzes the stored information to identify events of importance within the stored information. The monitor component device may identify events of importance using a variety of processes. For example, the monitor component may identify events of importance by comparing data included in the stored information to one or more threshold parameter values. According to another example, the monitor component may identify events of importance by determining that a predefined parameter is being tracked by a dashboard widget.

If the monitor component identifies an event of importance, the monitor component reports the event information corresponding to the event and clears the data buffer in act 510. This event information may include the values of variable or other stored information. In some embodiments, the reporting process reads configuration information identifying a dashboard component designated to receive event reports. The identified dashboard component may be executing locally on the automatic control device or executing remotely on a different and distinct automatic control device.

If the monitor component does not identify an event of importance, the monitor component determines whether a reporting time interval has transpired in act 512. If so, the monitor component reports the stored variable values and clears the data buffer in act 510. Otherwise, the monitor component determines whether a shutdown of the automatic control device is imminent in act 512. If so, the monitor component terminates the process 500. Otherwise, the monitor component executes the act 502.

Other embodiments perform notification processes that enable an automatic control device to monitor itself and the industrial processes controlled by the automatic control device and to report potential security issues via a passive security component, such as the passive security component 204 described above with reference to FIG. 2. One embodiment of such a notification process is illustrated in FIG. 31. According to this embodiment, the notification process 3100 includes acts of several acts which are described further below.

In act 3102, the passive security component executing the notification process 3100 scans an automatic control device, such as any of the automatic control devices 108, 110, 112, and 114 described above with reference to FIG. 1, for potential security issues. Actions taken by the passive security component during execution of the act 3102 may include reading and comparing a variety of information locally stored on the automatic control device. This information may include information descriptive of user accounts, logon credentials, network settings, and other information relating to the configuration and contents of the automatic control device.

In act 3104, the passive security component determines whether a potential security issue is present. If not, the passive security component terminates the process 3100. Otherwise, the passive security component presents a warning notification corresponding to the next detected potential security issue in act 3106. In at least one embodiment, the passive security component presents the warning notification via a browser-based user interface, such as a user interface served by the web server 12 described above with reference to FIG. 2.

In act 3108, the passive security component receives a response to the warning notification via the user interface. In act 3110, the passive security component determines whether the response includes information requesting that the potential security issue corresponding to the warning notification has been accepted as not posing an actual security threat. If so, the passive security component records information reflecting that the potential security issue has been accepted in act 3112. Otherwise, the passive security component executes act 3114.

In the act 3114, the passive security component determines whether the response includes information requesting that the potential security issue corresponding to the warning notification be addressed. If so, the passive security component executes a corrective component associated with the potential security issue in act 3116. The corrective component facilitates correction of the potential security issue and varies based on the potential security issue to be addressed. If the response does not include information indicating that the potential security issue should be addressed, the passive security component executes act 3118.

In the act 3118, the passive security component determines whether the response includes information requesting additional information regarding the potential security issue. If so, the passive security component provides additional information regarding the potential security issue in act 3120. The additional information may include further details regarding the potential security issue or may provide additional information as to why the potential security issue is considered a potential security issue. For example, where the passive security component detects a weak password, the additional information may include a link to a screen that is configured to display additional information on what is considered a strong password and that is configured to receive password changes. In another example, where the passive security component detects a traffic overload on a port, the additional information may include a link to port statistics and bandwidth monitoring information that provides diagnostics with indications of potential sources of the overload and potential solutions for each potential source. If the response does not include information indicating a request for additional information regarding the potential security issue, the passive security component executes act 3122.

In the act 3124, the passive security component closes the warning notification presented in the act 3106. In the act 3122, the passive security component determines whether additional, unreported potential security issues were identified in the act 3104. If so, the passive security component executes the act 3106. Otherwise, the passive security component terminates the notification process 3100.

Processes 400, 500, and 3100 each depict one particular sequence of acts in a particular example. The acts included in these processes may be performed by, or using, one or more computer systems or automatic control devices specially configured as discussed herein. Some acts are optional and, as such, may be omitted in accord with one or more examples. Additionally, the order of acts can be altered, or other acts can be added, without departing from the scope of the systems and methods discussed herein. Furthermore, as discussed above, in at least one embodiment, the acts are performed on particular, specially configured machines, namely an automation control system configured according to the examples and embodiments disclosed herein.

### Interface Components

As described above, some embodiments disclosed herein publish ACD information via a dashboard interface. In some examples, the dashboard interface is rendered by a user interface on one or more computer systems. FIG. 6 illustrates an exemplary dashboard interface 600 according to one such embodiment. As shown in FIG. 6, the dashboard interface 600 includes a widgets menu 604 and dashboard display area 606.

Each widget represented in the widgets menu 604 provides a visual representation of one or more variable values included in ACD information published to the dashboard interface from one or more automatic control devices. As illustrated in FIG. 6, the widgets provide a variety of ACD information including production status information, process completion information, historical and current tension information, tank content information, and power meter information. Also, as shown in FIG. 6, these elements of ACD information are displayed using a variety of user interface elements, such as graphs, dials, and trend arrows.

In the embodiment shown in FIG. 6, the widgets menu 604 includes representations of several dashboard widgets. Responsive to receiving an indication that a user wishes to add a widget to the dashboard display area 606, the dashboard interface executes the dashboard widget represented by the representation. Examples of indications that the user wishes to add the widget include a drag and drop of one of the representations of the widget from the widgets menu 604 into the display area 606.

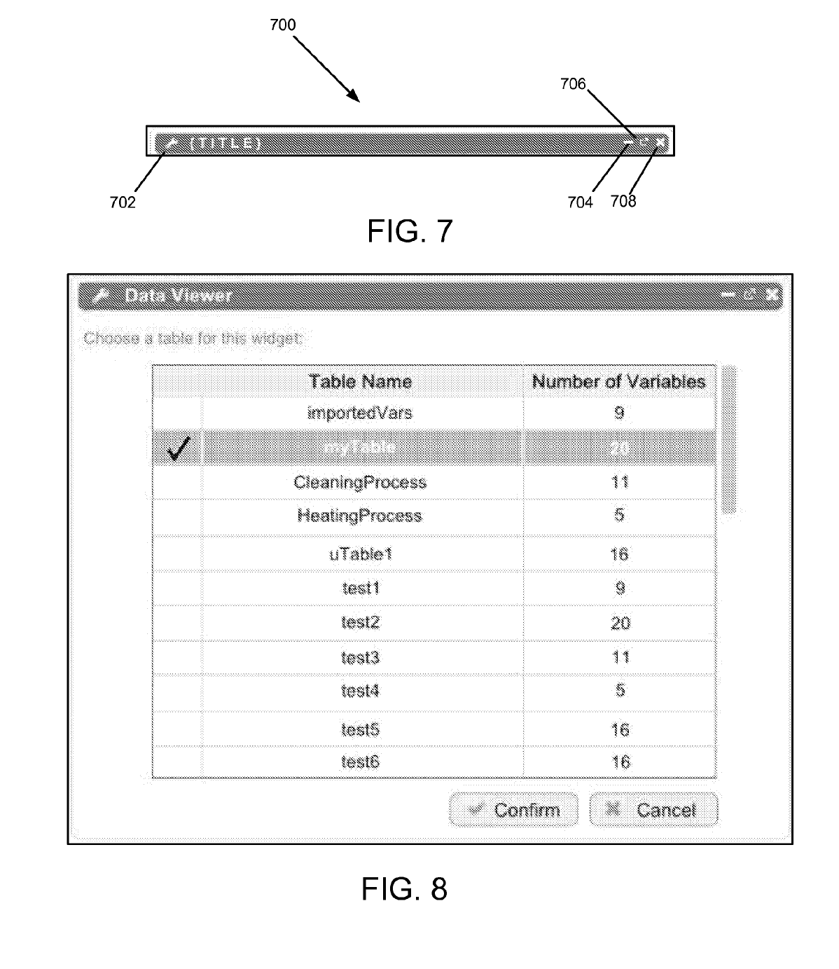

Continuing with the embodiment illustrated in FIG. 6, responsive to receiving an indication that a user wishes to move a widget within the dashboard display area 606, the dashboard interface alters the value of the location parameter associated with the widget to reflect the move. Examples of indications that the user wishes to move the widget include a drag and drop of the widget from one location to another within the dashboard display area 606. Also, responsive to receiving an indication that the user wishes to edit, close, minimize, or maximize a widget, the dashboard interface performs the indicated function. Examples of indications that the user wishes to edit, close, minimize, or maximize the widget include receiving a click within a predefined area at the top of widget. FIG. 7 shows an exemplary title bar 700 that illustrates predefined areas corresponding to editing options (702), minimizing (704), maximizing (706), and deleting (708) a widget.

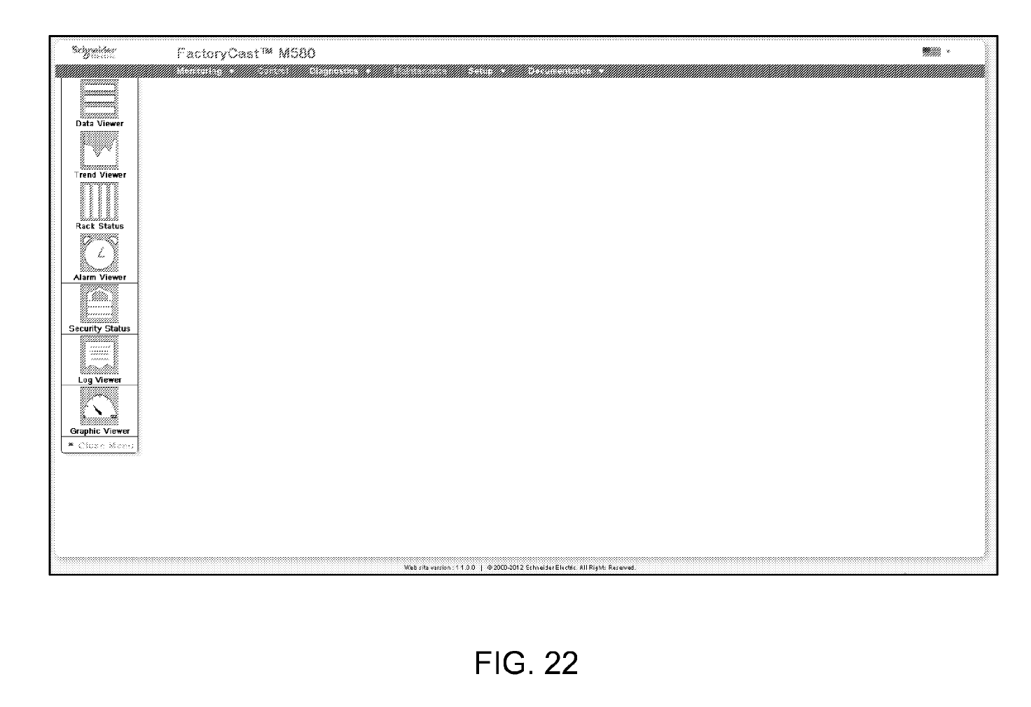

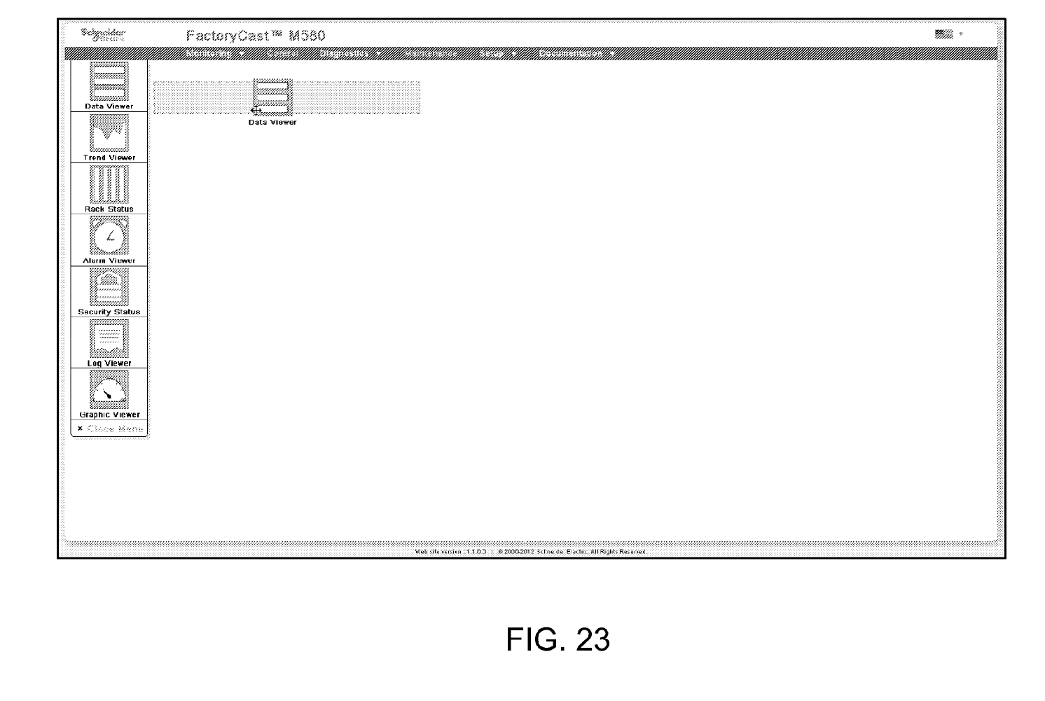

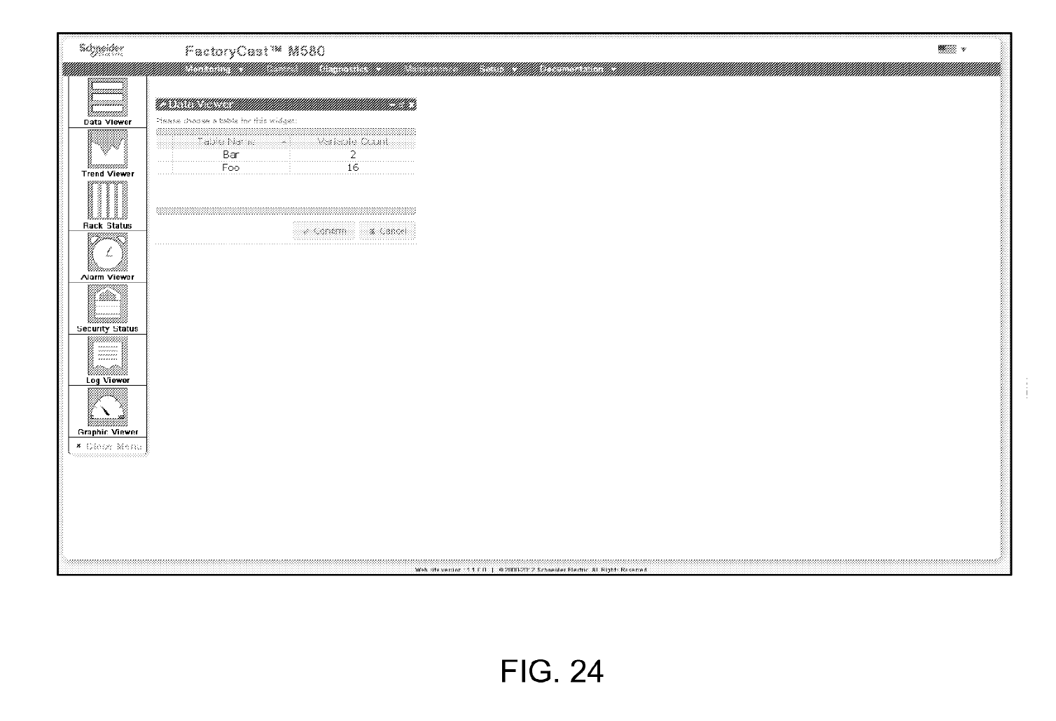

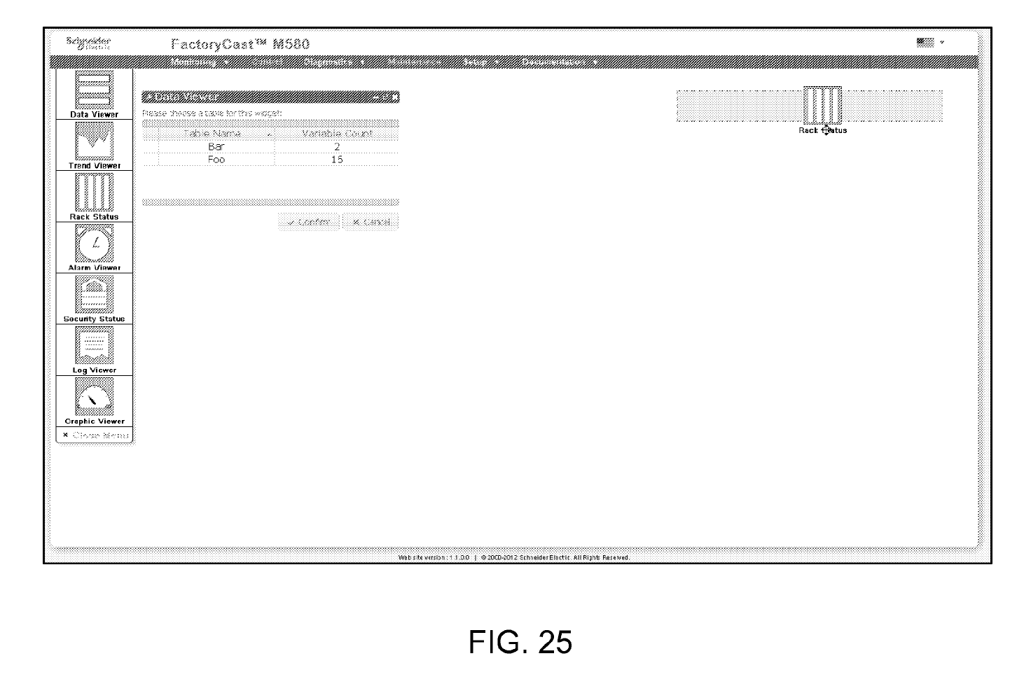

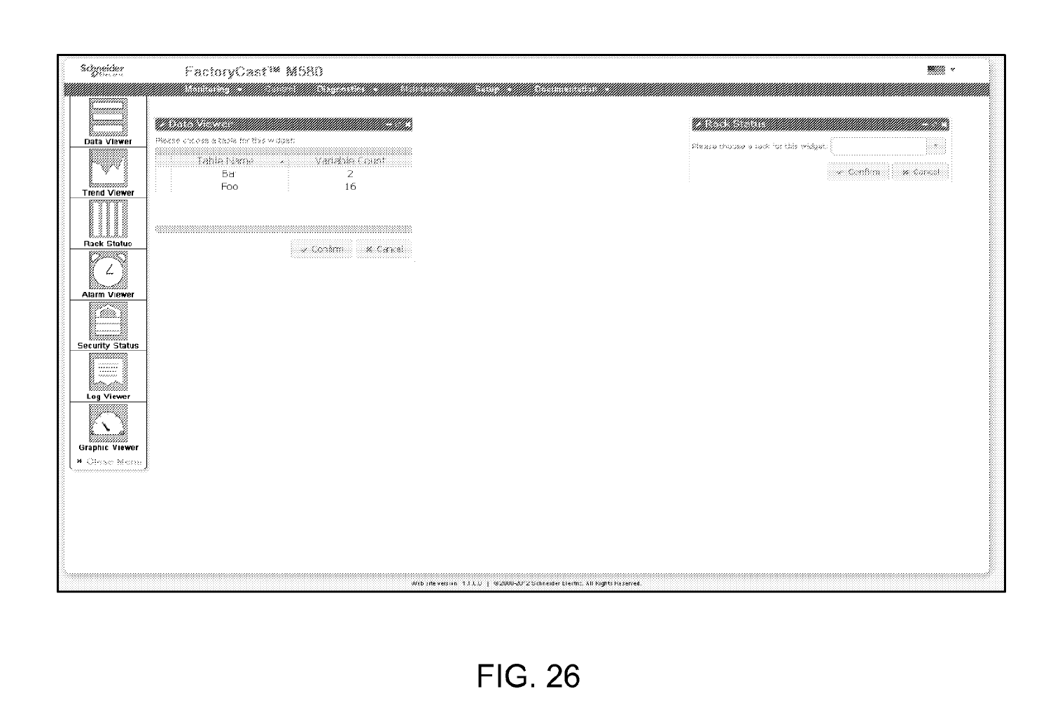

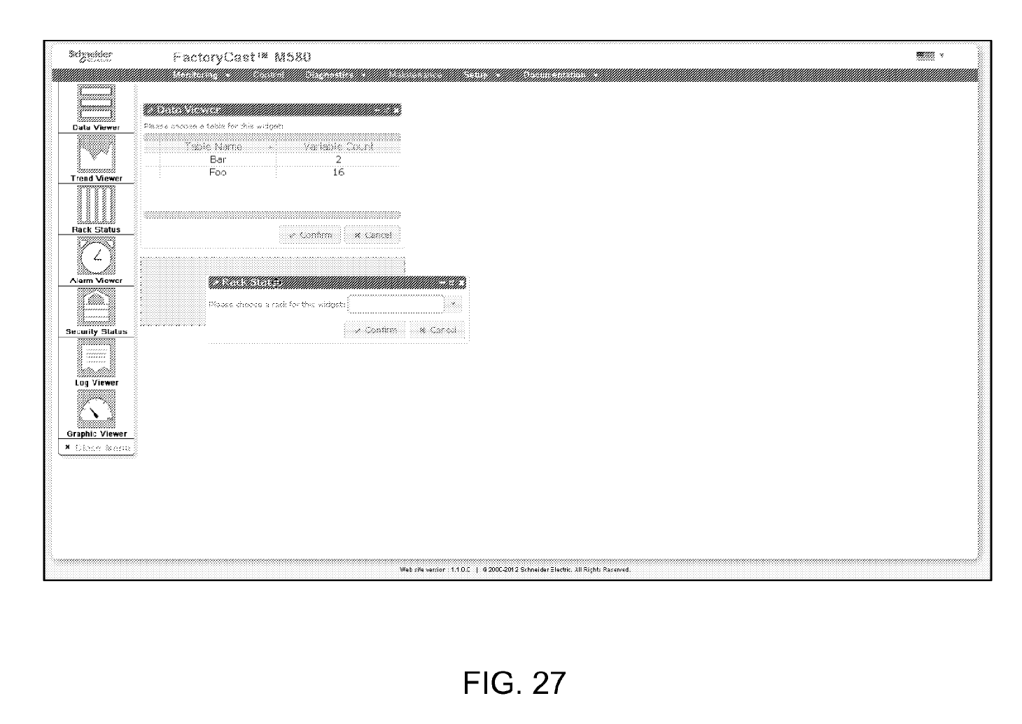

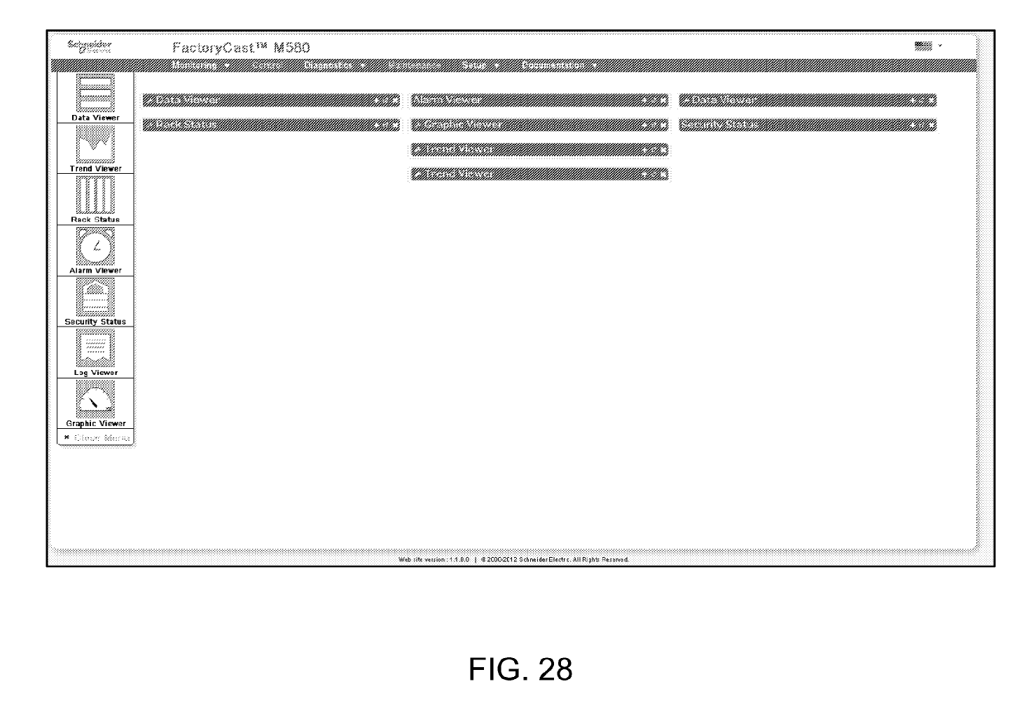

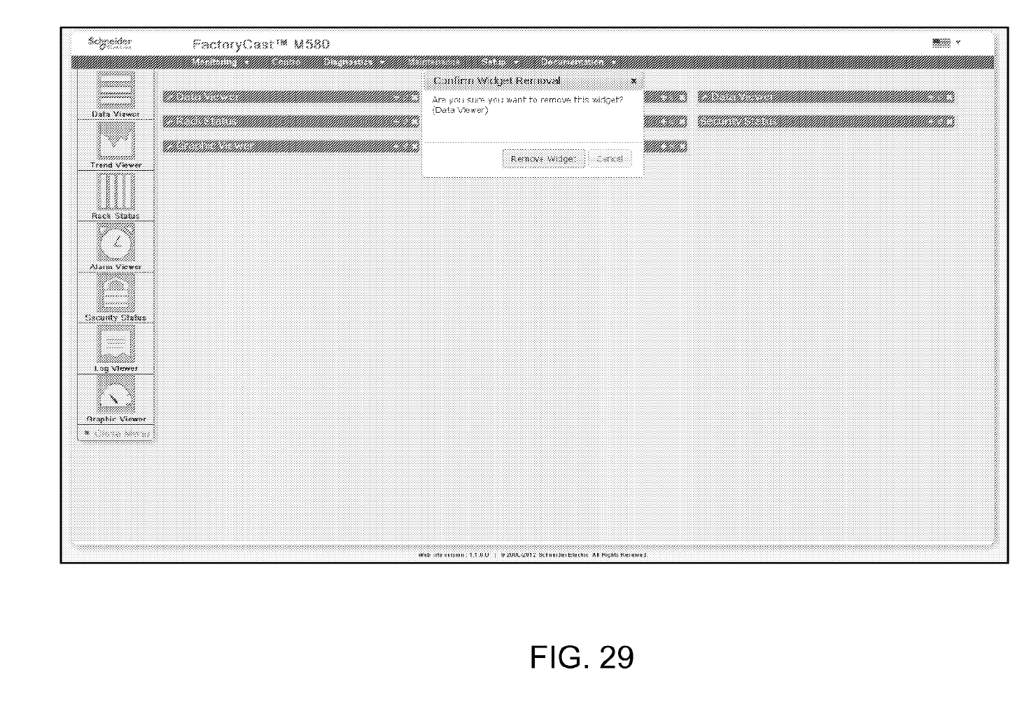

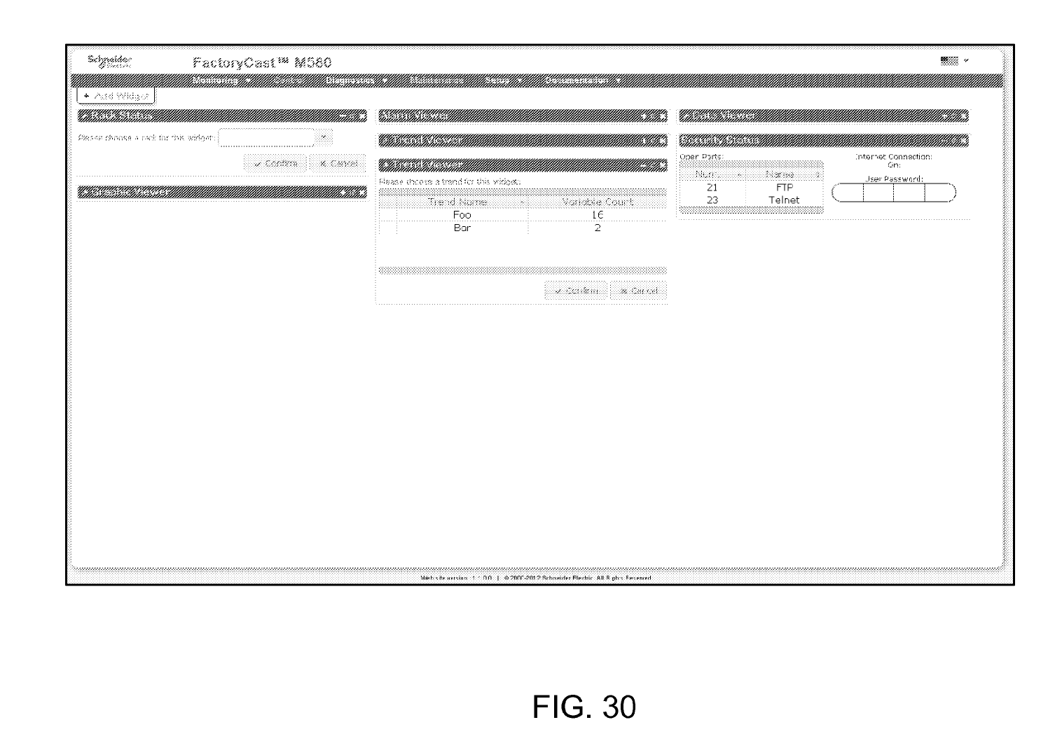

FIGS. 22-30 illustrate several exemplary manipulations of widgets performed via the dashboard interface. FIG. 22 shows a dashboard interface, such as the dashboard interface 600 described above with reference to FIG. 6, prior to addition of any widgets. FIG. 23 depicts a drag of data viewer widget, which is described further below, from a widgets menu, such as the widgets menu 604 described above with reference to FIG. 6, to a dashboard display area, such as the dashboard display area 606 described above with reference to FIG. 6. FIG. 24 illustrates the dashboard interface after the data viewer widget has been dropped into the dashboard display area. FIG. 25 shows a drag of a rack status widget, which is described further below, from the widgets menu to the dashboard display area. FIG. 26 depicts the dashboard interface after the rack status widget has been dropped into the dashboard display area. FIG. 27 illustrates a drag of the rack status widget from its previous location within the dashboard display area to a new location within the dashboard display area. FIG. 28 illustrates the dashboard interface with several widgets added to the dashboard display area, with each widget being minimized FIG. 29 shows a confirmation window displayed by a widget responsive to receiving an indication, such as a click over a predefined area of the title bar of the widget, that the user wishes to delete the widget. FIG. 30 depicts the dashboard interface with the widgets menu closed.

Returning to the embodiment illustrated in FIG. 6, available dashboard widgets include a data viewer widget 608, a graphic viewer widget 610, a log viewer widget 612, an alarm viewer widget 614, a rack status widget 616, a security status widget 618, and a trend viewer widget 620. The data viewer widget 608 displays current values of ACD information (e.g., variables from one or more tables) stored on an automatic control device. In some embodiments, the data viewer widget refreshes the values of the ACD information as refreshed ACD information is received or according to a refresh rate parameter defined within the options associated with the data viewer widget 608. The options associated with the data viewer widget 608 further include a source table from which the data viewer widget 608 reads information.

FIG. 8 illustrates a screen presented by the data viewer widget 608 and through which the data viewer widget 608 receives an indication as to which table is its source table. In FIG. 8, the “myTable” table is currently selected as the source table. In some embodiments, if no tables are available for selection, the data viewer widget 608 presents information stating that no tables currently exist and provides an actionable element that, if selected, adds a new table.

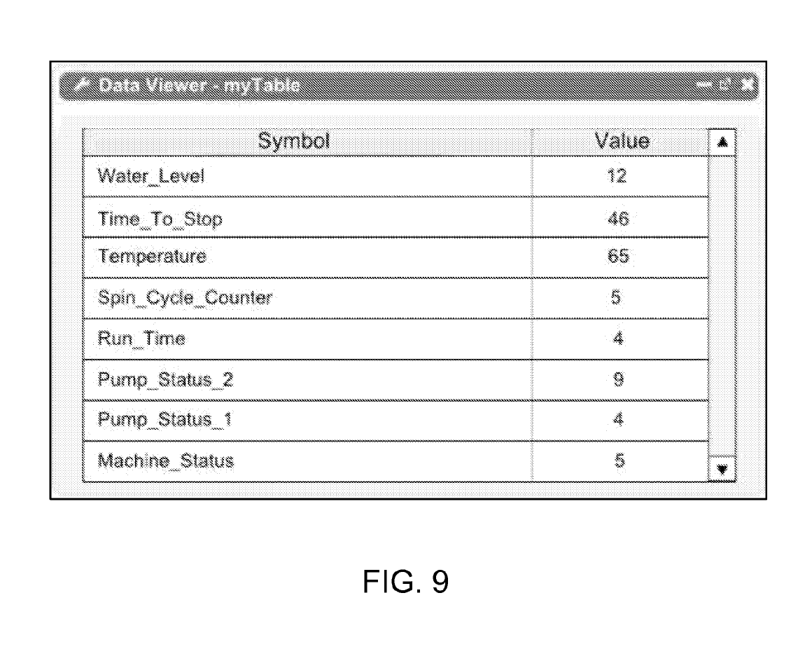

Once a source table is selected, the data viewer widget 608 displays the variables included in its source table and their values. In some embodiments, the data viewer widget 608 sorts the variables by name in response to receiving an indication that the user wishes the sort to occur. Examples of such indication include receiving a click on the header of the variable name column. FIG. 9 illustrates the data viewer widget 608 displaying the contents of the “myTable” table.

Continuing with this embodiment, responsive to receiving an indication that a user has selected one of the variables displayed by the data viewer widget 608, the data viewer widget 608 displays a representation of the historical trend of the value of the selected variable, in conjunction with additional information about the selected variable. Examples of indications that the user wishes to select a variable include receiving a click on the symbol name associated with the variable. The additional information displayed concerning the variable may include a symbol name, data type, format, current value, address, and comments regarding the variable.

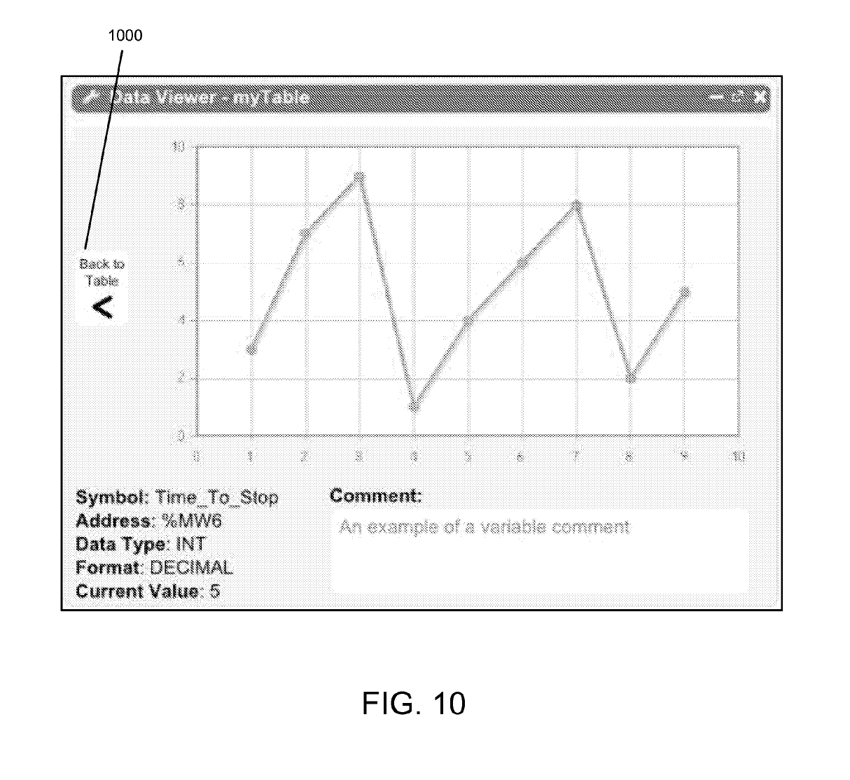

FIG. 10 illustrates the data viewer widget 608 displaying an historical trend of the “Time_To_Stop” variable. As shown in FIG. 10, responsive to receiving an indication that the user wishes to navigate back to the table screen, such as a click within the “Back to Table” area 1000, the data viewer widget 608 displays the screen illustrated in FIG. 9.

Returning to the embodiment illustrated in FIG. 6, the trend viewer widget 620 displays a graphical representation of the current and historical ACD information. In some embodiments, the graphical representation includes a line graph or a bar graph. The options associated with the trend viewer widget 620 include the graph type and a source trend from which the trend viewer widget 620 generates information to graph. In some embodiments, a source trend includes a collection of one or more variables of interest and a refresh rate parameter that defines the frequency with which the trend viewer widget 620 refreshes the trend graph with updated values of the variables included in the collection.

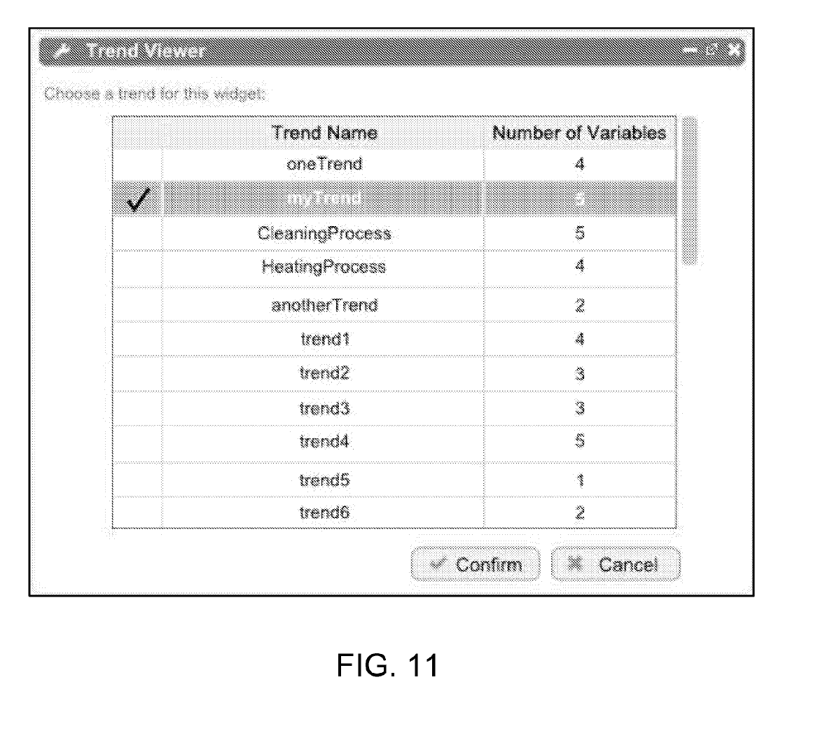

FIG. 11 illustrates a screen presented by the trend viewer widget 620 and through which the data viewer widget 620 receives an indication as to which trend is its source trend. In FIG. 11, the “myTrend” trend is currently selected as the source trend. In some embodiments, if no trends are available for selection, the trend viewer widget 620 presents information stating that no trends currently exist and provides an actionable element that, if selected, adds a new trend.

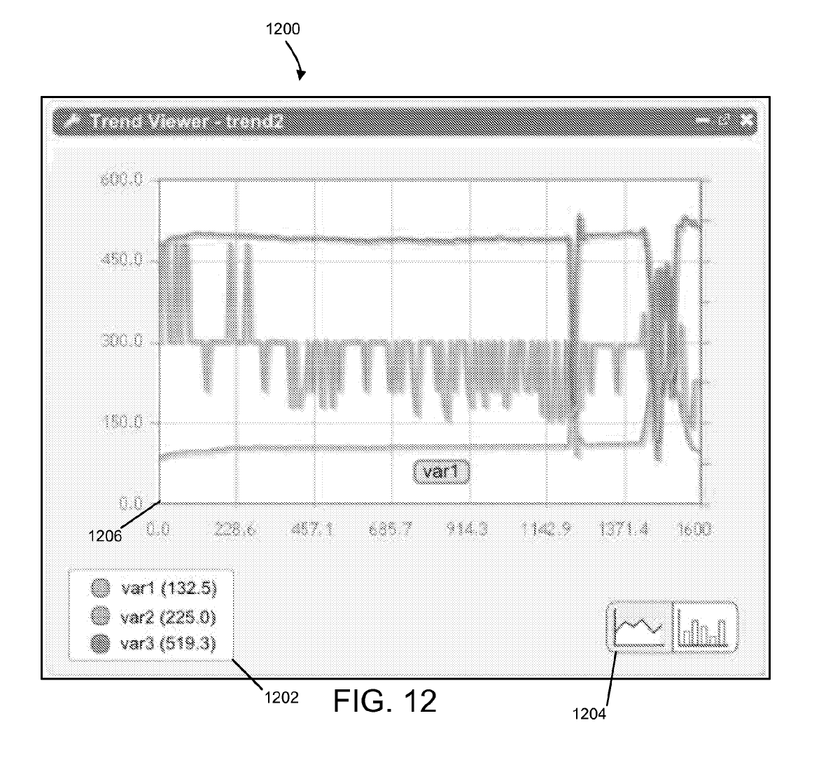

Once a source trend is selected, the trend viewer widget 620 displays the variables included in its source trend and their current and historical values. FIG. 12 illustrates the data viewer widget 608 displaying the “myTrend” trend. As shown in FIG. 12, the screen 1200 includes a legend 1202, a graph type control 1204, and a graph display area 1206. The legend 1202 displays information associating graph elements with the variables represented by the graph elements. The graph type control 1204 indicates the currently selected graph type. Responsive to receiving an indication that the user wishes to select a different graph type, such as a click in the area of the graph type control 1204 corresponding to the graph type not currently selected, the trend viewer widget 620 changes the graph type displayed in the graph display area 1206. In addition, responsive to receiving an indication that a user is interested in a variable corresponding to a particular graphical element (e.g., hovering over a particular graphical element within the graph display area 1206), the trend viewer widget 620 displays additional information indicating the variable and value represented by the graphical element.

Returning to the embodiment illustrated in FIG. 6, the rack status widget 616 displays information associated with devices installed within a rack associated with the automatic control device. This information may include a high level overview of the devices within the rack, the physical layout of the rack, names of devices included in the rack and the status of each device. The options associated with the rack status widget 616 include a source rack from which the rack status widget 616 generates information for display. In some embodiments, a source rack includes a collection of one or more variables that characterize the location, name, and status of equipment co-located within a rack.

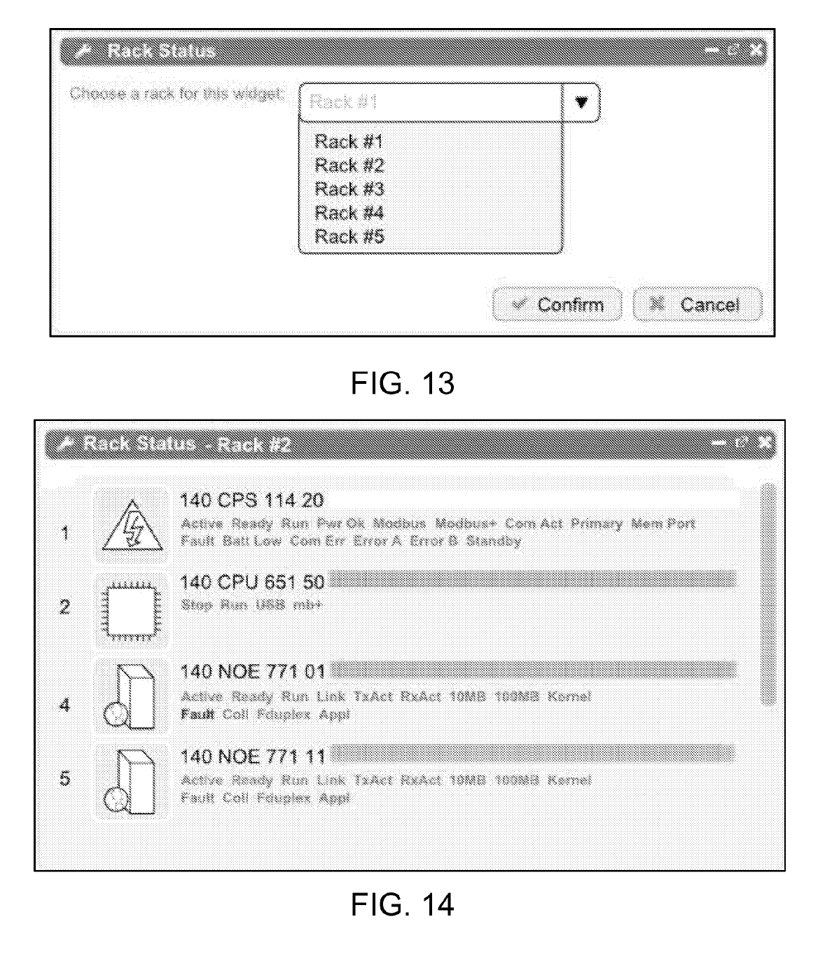

FIG. 13 illustrates a screen presented by the rack status widget 616 and through which the rack status widget 616 receives an indication as to which rack is its source rack. In FIG. 13, any of “Rack #1” through “Rack #5” may be selected as the source rack. Once a source rack is selected, the rack status widget 616 displays a variety of graphical and textual information indicating the location, name and status of equipment included in the rack. FIG. 12 illustrates the rack status widget 616 displaying information associated with the “Rack#2” rack.

Returning to the embodiment illustrated in FIG. 6, the security status widget 618 displays security related information associated with an automatic control device. This information may include a list of open ports (and services conventionally associated with each port), an indication as to whether the automatic control device has internet connectivity, and an indication as to the strength of the user's password. In some embodiments, the password strength is determined and stored prior to the password being hashed. FIG. 15 illustrates a screen displayed by the security status widget 618. In other embodiments, the security status widget 618 indicates whether any configuration information affecting the operation of the automatic control device (e.g., ladder logic) has changed within a past period of time defined by a time parameter having a configurable duration. In these embodiments, the security status widget 618 may store an identifier of the entity requesting the change, and the previous value of the configuration information.

As described above, in some embodiments, the passive security component 204 is implemented within the security status widget 618. In these embodiments, the security status widget 618 may include any subset of the features described herein with reference to the passive security component 204. In other embodiments, the passive security component 204 provides security status information outside of the dashboard interface. FIG. 32 illustrates one of these embodiments. As shown, FIG. 32 includes a screen 3200 that includes a banner 3202 displaying passive security information. Thus embodiments disclosed herein may provide passive security information via dashboard interfaces and other interfaces.

Continuing with the embodiment illustrated in FIG. 6, the alarm view widget 614 displays and manages alarm information included in the ACD information. This alarm information may include list of alarms. Each alarm may be associated with an alarm description, date and time of occurrence, severity (e.g. critical, warning, And OK). FIG. 16 illustrates a screen 1600 displayed by the alarm view widget 614.

The screen 1600 includes acknowledge button 1602, acknowledge all button 1604, delete button 1606, delete all button 1608 and alarm display list 1610. Each alarm within the alarm list 1610 includes a severity indicator 1612 and a checkbox 1614. As shown in FIG. 16, the severity indicator 1612 reflecting a critical severity is colored red and the icon reflecting a warning is colored yellow.

In the embodiment illustrated in FIG. 16, responsive to receiving a click upon the acknowledge button 1602, the alarm view widget 614 acknowledges all of the alarms in the alarm list 1610 having a checked checkbox 1614. Responsive to receiving a click upon the acknowledgement all button 1604, the alarm view widget 614 acknowledges all of the alarms in the alarm list 1610. Responsive to receiving a click upon the delete button 1606, the alarm view widget 614 deletes all of the alarms in the alarm list 1610 having a checked checkbox 1614. Responsive to receiving a click upon the delete all button 1604, the alarm view widget 614 deletes all of the alarms in the alarm list 1610.

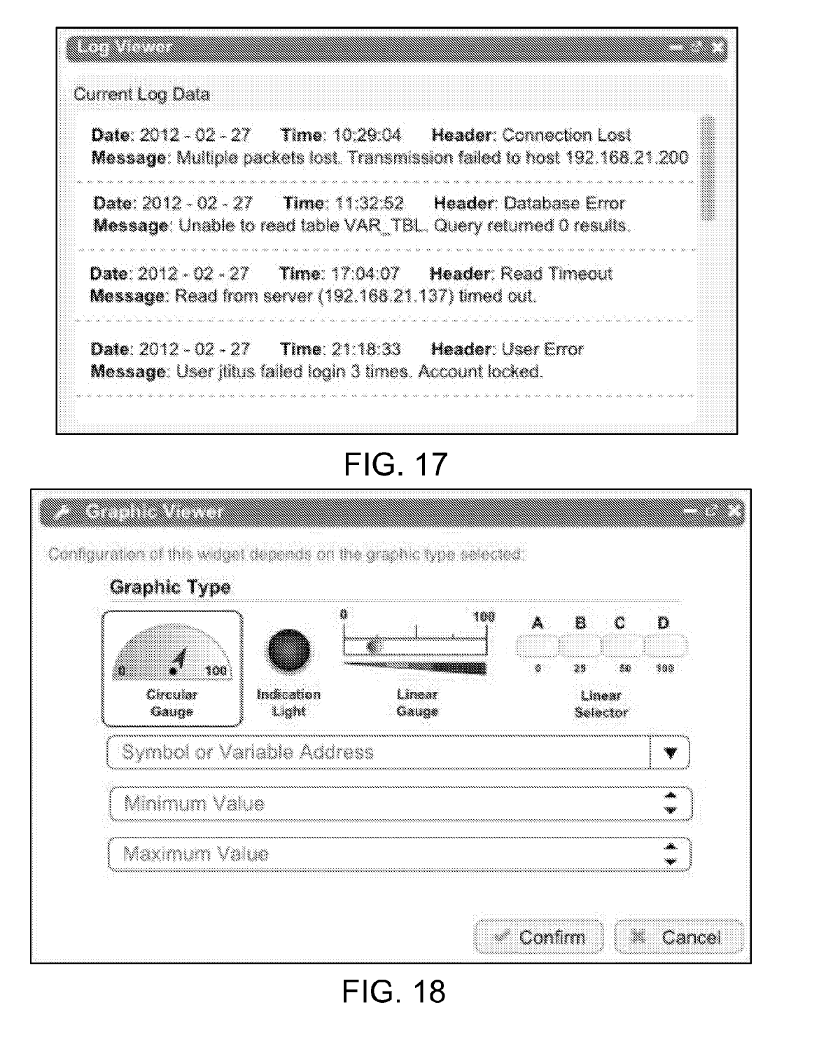

Returning to the embodiment illustrated in FIG. 6, the log viewer widget 612 displays the content of any log files included in the ACD information. This log information may include the date and time of each log event, a header providing a short description of each log event, and a message providing more detailed information regarding the log event. In some embodiments, the log information is stored in XML format. FIG. 17 illustrates a screen displayed by the log viewer widget 612.

Returning to the embodiment illustrated in FIG. 6, the graphic viewer widget 610 displays a graphical representation of the current values of ACD information (e.g., a source variable). The options associated with the graphic viewer widget 610 include a graph type parameter and other options that depend on the graph type selected. According to some embodiments, the values available for the graph type parameter represent a circular gauge, an indication light, a vertical/horizontal gauge, and a vertical/horizontal selector.

FIG. 18 illustrates a screen presented by the graphic viewer widget 610 and through which graphic viewer widget 610 receives additional options to associate with a circular gauge graph type. As shown in FIG. 18, these additional options include a symbol name or address associated with the source variable, a minimum value to be displayed in the circular gauge, and a maximum value to be displayed in the circular gauge.

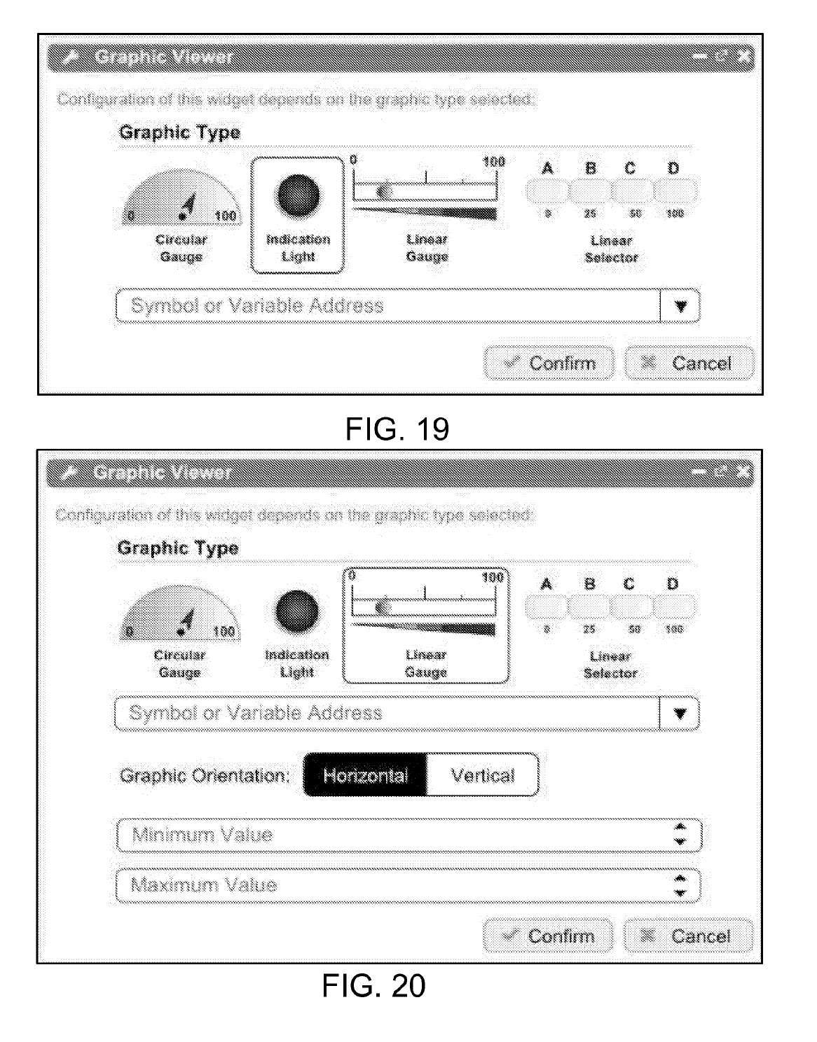

FIG. 19 illustrates a screen presented by the graphic viewer widget 610 and through which graphic viewer widget 610 receives additional options to associate with an indication light graph type. As shown in FIG. 19, these additional options include a symbol name or address associated with the source variable.

FIG. 20 illustrates a screen presented by the graphic viewer widget 610 and through which graphic viewer widget 610 receives additional options to associate with a linear gauge graph type. As shown in FIG. 20, these additional options include a symbol name or address associated with the source variable, an orientation in which the linear gauge should be displayed, a minimum value to be displayed in the linear gauge, and a maximum value to be displayed in the linear gauge.

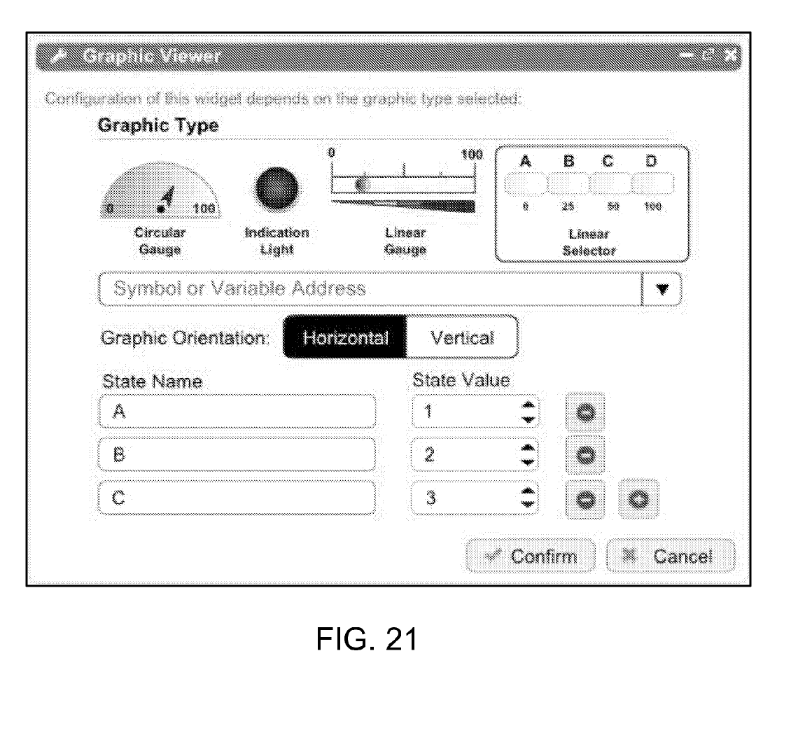

FIG. 21 illustrates a screen presented by the graphic viewer widget 610 and through which graphic viewer widget 610 receives additional options to associate with a linear selector graph type. As shown in FIG. 20, these additional options include a symbol name or address associated with the source variable, an orientation in which the linear selector should be displayed, and a series of state names and threshold values used to determine when sections of the linear selector are illuminated.

After the options are configured, the graphic viewer widget 610 displays a graphical representation of the source variable using the graph type and additional options. For example, the graphic viewer widget 610 illustrates a circular gauge graph type in conjunction with a variable symbol name of “rotation_speed,” a minimum value of 0, and a maximum value of 10000.

Some embodiments include additional widgets such as a message board widget. The message board widget receives message information, stores the message information, and displays stored message information to users of the automatic control device. In one embodiment, the message board widget displays information only to users who are associated with the user logged into the automatic control device when the message information was received. In this way, the message board widget provides members of a team or other group with a convenient way to share information regarding a particular automatic control device.

In other embodiments, widgets display ACD information associated with automatic control devices distinct from the automatic control device providing the dashboard interface. In these embodiments, the widgets may include a visual indication that the information displayed in the widget reflects ACD information from another automatic control device. For instance, in one embodiment, an identifier (e.g., an IP address) of a remote source automatic control device appears in the title bar of each widget that displays ACD information associated with remote source automatic control device. In another embodiment, widgets that display ACD information from remote source automatic control devices are highlighted or colored differently from widgets displaying ACD information associated with the automatic control device providing the dashboard interface. In still other embodiments, the dashboard interface executes a links widget that provides links to other dashboard interfaces presented by remote automatic control devices distinct from the automatic control device providing the dashboard interface including the links widget.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. An automatic control device configured to publish automatic control device (ACD) information, the automatic control device comprising:
a memory storing the ACD information;
at least one processor coupled to the memory;
an industrial protocol interface executed by the at least one processor and configured to exchange messages formatted according to the industrial protocol; and
a dashboard component executed by the at least one processor and configured to display the ACD information via at least one dashboard widget.

2. The automatic control device according to claim 1, wherein the least one widget includes at least one of a data viewer widget, a graphic viewer widget, a log viewer widget, an alarm viewer widget, a rack status widget, a security status widget, a trend viewer widget, links widget, and a message board widget.

3. The automatic control device according to claim 1, wherein the dashboard component is further configured to receive the ACD information from another automatic control device.

4. The automatic control device according to claim 1, wherein the dashboard component is further configured to add a dashboard widget responsive to a drag and drop of a representation of the dashboard widget.

5. The automatic control device according to claim 1, wherein the dashboard component is further configured to move the at least one dashboard widget responsive to a drag and drop of the at least one dashboard widget.

6. The automatic control device according to claim 1, wherein the dashboard component is further configured to remove the at least one dashboard widget responsive to a click on a predefined area of the at least one dashboard widget.

7. The automatic control device according to claim 1, wherein the dashboard component is further configured to:
identify a user logged onto the automatic control device;
determine that the user is associated with a dashboard widget and a plurality of options for the dashboard widget;
execute the dashboard widget using the plurality of options; and
display the dashboard widget.

8. A method of publishing ACD information, the method comprising:
generating, by an automatic control device, the ACD information through management of an industrial process;
storing the ACD information;
executing at least one dashboard widget; and
displaying the ACD information via the at least one dashboard widget.

9. The method according to claim 8, wherein executing the least one widget includes executing at least one of a data viewer widget, a graphic viewer widget, a log viewer widget, an alarm viewer widget, a rack status widget, a security status widget, a trend viewer widget, links widget, and a message board widget.

10. The method according to claim 8, further comprising receiving the ACD information from another automatic control device.

11. The method according to claim 8, further comprising adding a dashboard widget responsive to a drag and drop of a representation of the dashboard widget.

12. The method according to claim 8, further comprising moving the at least one dashboard widget responsive to a drag and drop of the at least one dashboard widget.

13. The method according to claim 8, further comprising removing the at least one dashboard widget responsive receiving a click on a predefined area of the at least one dashboard widget.

14. The method according to claim 8, further comprising:
identifying a user logged onto the automatic control device;
determining that the user is associated with a dashboard widget and a plurality of options for the dashboard widget;
executing the dashboard widget using the plurality of options; and
displaying the dashboard widget.

15. A non-transitory computer readable medium storing sequences of instructions for publishing ACD information including instructions encoded to instruct at least one processor to:
generate the ACD information through management of an industrial process;
store the ACD information;
execute at least one dashboard widget; and
display the ACD information via the at least one dashboard widget.

16. The computer readable medium according to claim 15, wherein the instructions encoded to instruct at least one processor to execute the at least one dashboard widget instruct the at least one processor to execute at least one of a data viewer widget, a graphic viewer widget, a log viewer widget, an alarm viewer widget, a rack status widget, a security status widget, a trend viewer widget, links widget, and a message board widget.

17. The computer readable medium according to claim 15, wherein the instructions are encoded to further instruct the at least one processor to receive the ACD information from another automatic control device.

18. The computer readable medium according to claim 15, wherein the instructions are encoded to further instruct the at least one processor to add a dashboard widget responsive to a drag and drop of a representation of the dashboard widget.

19. The computer readable medium according to claim 15, wherein the instructions are encoded to further instruct the at least one processor to move the at least one dashboard widget responsive to a drag and drop of the at least one dashboard widget.

20. The computer readable medium according to claim 15, wherein the instructions are encoded to further instruct the at least one processor to remove the at least one dashboard widget responsive receiving a click on a predefined area of the at least one dashboard widget.
